(19) United States
(12) Patent Application Publication
(10) Pub. No.: US 2024/0048061 A1
(43) Pub. Date: Feb. 8, 2024

(54) SINGLE-STAGE HALF-BRIDGE POINT OF LOAD CONVERTER WITH QUASI-PEAK CYCLE BY CYCLE CURRENT CONTROLLER

(71) Applicants: Tuhin Subhra Sasmal, Vestal, NY (US); Pritam Das, Vestal, NY (US)

(72) Inventors: Tuhin Subhra Sasmal, Vestal, NY (US); Pritam Das, Vestal, NY (US)

(73) Assignee: The Research Foundation for The State University of New York, Binghamton, NY (US)

(21) Appl. No.: 18/353,062

(22) Filed: Jul. 14, 2023

Related U.S. Application Data
(60) Provisional application No. 63/393,801, filed on Jul. 29, 2022.

(51) Int. Cl. H02M 3/335; H02M 1/00

(52) U.S. Cl. CPC H02M 3/33592; H02M 1/0009; H02M 1/0025; H02M 3/33515

(57) ABSTRACT

A voltage converter, method for operating a voltage converter, and a controller for a voltage converter is provided. An input stage, comprising a first pair of switches is configured to receive electrical power and generate therefrom an oscillating waveform in a transformer circuit comprising an inductor, the oscillating waveform being associated with an inductor current in the inductor. A synchronous rectifier stage, comprising a second pair of switches, is configured to produce a rectified output voltage from power transferred through the transformer circuit. A controller, producing switch control signals, is configured to operate the first pair of switches in a soft switching mode to produce the oscillating waveform having a switching rate dependent on the rectified output voltage and a switching duty cycle dependent on the inductor current; and synchronously operate the second pair of switches to produce the rectified output voltage.

### CROSS REFERENCE TO RELATED APPLICATIONS

The present application is a non-provisional of, and claims benefit of priority under 35 U.S.C. § 119(e) from, U.S. Provisional Patent Application No. 63/393,801, filed Jul. 29, 2022, the entirety of which is expressly incorporated herein by reference.

### FIELD OF THE INVENTION

The present invention relates to a single-stage half-bridge converter providing a high ratio step-down voltage Point of Load converter.

### BACKGROUND OF THE INVENTION

Each reference cited herein is expressly incorporated by reference herein in its entirety for all purposes.

With the advancement of internet usage in daily life big data processing and cloud computing become essential for present scenario. This leads to rapid growth of data centers all over the world. Essential DC power distribution system, due to higher efficiency, replaces traditional AC system in data center. In DC power supply architecture for the data center, a 12 V DC source is replaced by a 48 V DC source to minimize the inevitable resistive loss in power transmission system. On the other hand, at the output end, voltage requirement for computer equipment like CPU and GPU in new motherboard architectures is sinking gradually to 1 V or below. Li, Yanchao, Xiaofeng Lyu, Dong Cao, Shuai Jiang, and Chenhao Nan. “A 98.55% efficiency switched-tank converter for data center application.” IEEE Transactions on Industry Applications 54, no. 6 (2018): 6205-6222.

This new trend is approached to reduce dynamic power consumption of the logic gates in CPU as the power consumption is proportional to square of the input voltage to CPU. Enhanced Intel® SpeedStep® Technology for the Intel® Pentium® M Processor, March 2004. download.intel.com/design/network/papers/30117401.pdf

This provides motivation to make a 48 V DC to 1.2 V or 1 V or sub-one volt voltage regulator module (VRM) to supply power to the computing load. There are two main challenges in designing Point of Load (PoL) converters. First one is high step-down of input voltage and second important aspect is to deal-with very high slew rate of the dynamic behavior of load transients. Various types of converters with different topologies have been adopted to satisfy the load demand for PoL applications. Existing approaches are mainly classified into two groups: switched-capacitor (SC) converters and resonant tank converters. These have respective advantages, but when it comes to the point of large power demand for present server system applications with reasonably compact size, efficiency and cost, they do not offer a very good optimum solution. That is, the available solutions may be large, low efficiency, or expensive to implement.

Although switched capacitor converters can achieve high power density, pure switched capacitor converters will control output voltage in discrete steps depending on the number of the switching capacitor stages. Li et al. (2018). Hybrid capacitor-inductor based switched capacitor converters have better resolution in output voltage control, but overall such converters have a significantly large number of power devices, and related gate drive circuitry, for driving multiple high side floating switch devices leading to high cost, and size. Baek, Jaeil, Ping Wang, Youssef Elasser, Yenan Chen, Shuai Jiang, and Minjie Chen. “Lego-pol: A 48v-1.5 v 300a merged-two-stage hybrid converter for ultra-high-current microprocessors.” In 2020 IEEE Applied Power Electronics Conference and Exposition (APEC), pp. 490-497. IEEE, 2020; Chen, Minjie, Khurram K. Afridi, Sombuddha Chakraborty, and David J. Perreault. “Multitrack power conversion architecture.” IEEE Transactions on Power Electronics 32, no. 1 (2016): 325-340.

Additionally, to regulate output voltage with very large and fast load transients, incorporation of a DC-DC stage mostly operating with lossy hard switching and magnetics, reduce the power density and efficiency achieved by the switched capacitor circuit. To avoid poor efficiency in a two-stage converter, single-stage resonant-tank based switch capacitor converters are introduced in Chen, Jikang. “Resonant switched capacitor DC-DC converter with stackable conversion ratios.” In Electrical Engineering and Computer Sciences. University of California at Berkeley, 2016, www2.eecs.berkeley.edu/Pubs/TechRpts/2016/EECS-2016-187.html. However, this suffers from poor power density, as the load current flowing through the inductor and also the large swing of current in the output capacitor demands a multi-phase buck converter, which increases switch count and degrades power density. To reduce switch count in the output-stage, single-phase buck converter module is incorporated in Jiang et al., “Switched Tank Converter” U.S. Pat. No. 9,917,517 (Mar. 13, 2018). However, this approach leads to a large inductor size to carry total load current which eventually makes the system bulky.

With resonant power converters, high efficiency (>98%) and very high-power density (1 kW/liter) can be achieved because of inherent natural soft switching arising from the resonant tank operation, which reduces frequency dependent switching losses in power devices. The industry has used resonant converters in tandem with other DC-DC converters mostly in cascaded form, to overcome the natural sluggish response of either average current controlled or voltage controlled resonant converters, which fail to meet the fast-transient response needed in Point of Load applications.

VICOR introduced an inductive link DC-DC converter to generate an intermediate voltage level, which is followed by a resonant tank stage. Khatua, Somnath, Debaprasad Kastha, and Santanu Kapat. “A new single-stage 48-V-input VRM topology using an isolated stacked half-bridge converter.” IEEE Transactions on Power Electronics 35, no. 11 (2020): 11976-11987. This suffers, however, from unregulated voltage at output end.

In another solution, a single-stage sigma converter method is redefined. Ahmed, Mohamed H., Chao Fei, Fred C. Lee, and Qiang Li. “Single-stage high-efficiency 48/1 V sigma converter with integrated magnetics.” IEEE Transactions on Industrial Electronics 67, no. 1 (2019): 192-202. Here, one LLC resonant tank with a transformer to step down the input voltage, and a buck converter to regulate the output voltage are paralleled to satisfy the stringent load requirements. Most of the power, being processed by LLC resonant tank, elevates system efficiency in this topology. But this topology offers no galvanic isolation and demands a greater switch count at the secondary side for rectification and high load current.

A Transformer with a high turns ratio, to step down the input voltage, followed by a current doubler at the secondary rectifier side to meet load current, is an alternate option for Point of Load applications. To avoid need for the high turns ratio transformer per Ahmed et al (2019), a single-stage stacked half-bridge converter with a current doubler rectifier at the secondary is provided. But for Point of Load applications, inductors carrying large currents in current-doubler circuits raise the overall size of the converter higher. [0013] Hard switching occurs when there is an overlap between voltage and current when switching the transistor on and off. This overlap causes energy losses which can be minimized by increasing the di/dt and dv/dt. However, higher di/dt or dv/dt causes EMI to be generated. Therefore, the di/dt and dv/dt should be optimized to avoid EMI issues. To minimize the EMI effects and to improve efficiency, an improved hard switching technique called quasi-resonant switching was developed (mainly seen in flyback converters). In this mode, the transistor is turned on when the voltage across the drain and source is at a minimum (in a valley) in order to minimize the switching losses and to improve efficiency. Switching the transistor when the voltage is at a minimum helps reduce the hard switching effect which causes EMI. Switching when a valley is detected, rather than at a fixed frequency, introduces frequency jitter. This has the benefit of spreading the RF emissions and reducing EMI overall.

Soft switching begins when one electrical parameter reaches zero (current or voltage) before the switch is turned on or off. This has benefits in terms of losses. Also, since the switching loss per transition decreases, the semiconductors can be switched at higher frequency reducing the size of converter. The smooth resonant switching waveforms also minimize EMI. Common topologies like phase-shifted zero voltage switching (ZVS) and two inductors and a capacitor (LLC) are soft switched only at turn-on. For ZVS, the transistor will be turned on at zero VDS voltage to reduce the turn-on switching loss. For zero current switching (ZCS), the transistor will be turned off at zero I_{D} current to reduce the turn off switching loss.

Most resonant circuits are half- or full-bridge topologies (two or four transistors). As MOSFET transistors are switched on and off, energy can be left in the transistor and this can cause failure. Due to switching times, if this only happens occasionally a rugged body diode is sufficient. If due to fast transition times it happens continually, then a fast body diode is required to make sure all the energy will leave the transistor.
Ahmed, Mohamed H., Chao Fei, Fred C. Lee, and Qiang Li. “Single-stage high-efficiency 48/1 V sigma converter with integrated magnetics.” IEEE Transactions on Industrial Electronics 67, no. 1 (2019): 192-202.
Ahmed, Mohamed H., Fred C. Lee, and Qiang Li. “LLC converter with integrated magnetics application for 48V rack architecture in future data centers.” In 2019 IEEE Conference on Power Electronics and Renewable Energy (CPERE), pp. 437-443. IEEE, 2019.
Ahmed, Mohamed, Chao Fei, Fred C. Lee, and Qiang Li. “High-efficiency high-power-density 48/1V sigma converter voltage regulator module.” In 2017 IEEE Applied Power Electronics Conference and Exposition (APEC), pp. 2207-2212. IEEE, 2017.
Ambagahawaththa, Thilina S. “High Step-Down DC-DC Converter for Point of Load Applications.” In 2021 IEEE 30th International Symposium on Industrial Electronics (ISIE), pp. 1-6. IEEE, 2021.
Baek, Jaeil, Ping Wang, Shuai Jiang, and Minjie Chen. “Lego-pol: A 93.1% 54v-1.5 v 300a merged-two-stage hybrid converter with a linear extendable group operated point-of-load (lego-pol) architecture.” In 2019 20th Workshop on Control and Modeling for Power Electronics (COMPEL), pp. 1-8. IEEE, 2019.
Baek, Jaeil, Ping Wang, Youssef Elasser, Yenan Chen, Shuai Jiang, and Minjie Chen. “Lego-pol: A 48v-1.5 v 300a merged-two-stage hybrid converter for ultra-high-current microprocessors.” In 2020 IEEE Applied Power Electronics Conference and Exposition (APEC), pp. 490-497. IEEE, 2020.
Banerjee, Sarasij, Ashwin Chandwani, and Ayan Mallik. “Artificial Neural Network based Direct Inverse Control for a Novel 48V-1V DC/DC Converter.” In 2020 IEEE International Conference on Power Electronics, Drives and Energy Systems (PEDES), pp. 1-6. IEEE, 2020.
Cabizza, Stefano, Luca Corradini, Giorgio Spiazzi, and Cristian Garbossa. “Comparative Study of 48V-based Low-Power Automotive Architectures.” In 2020 IEEE 21st Workshop on Control and Modeling for Power Electronics (COMPEL), pp. 1-8. IEEE, 2020.
Cantrell, Bob, and Martin Haegerdal. “Seven reasons why power designers should implement 48 v to 1 v direct conversion.” In PCIM Europe 2017; International Exhibition and Conference for Power Electronics, Intelligent Motion, Renewable Energy and Energy Management, pp. 1-2. VDE, 2017.
Chandwani, Ashwin, and Ayan Mallik. “A Novel Design of High Step-down Non-Isolated DC/DC Converter.” In 2020 IEEE International Conference on Power Electronics, Drives and Energy Systems (PEDES), pp. 1-6. IEEE, 2020.
Chandwani, Ashwin, and Ayan Mallik. “Modelling and Control of a Novel High Step-down 48V-1V DC-DC Converter.” In 2021 IEEE 12th Energy Conversion Congress & Exposition-Asia (ECCE-Asia), pp. 708-713. IEEE, 2021.
Chen, Chen, Jin Liu, and Hoi Lee. “A 92.7%-Efficiency 30A 48V-to-1V Dual-Path Hybrid Dickson Converter for PoL Applications.” In 2021 IEEE Energy Conversion Congress and Exposition (ECCE), pp. 1989-1994. IEEE, 2021.
Chen, Jikang. “Resonant switched capacitor DC-DC converter with stackable conversion ratios.” In Electrical Engineering and Computer Sciences. University of California at Berkeley, 2016. www2.eecs.berkeley.edu/Pubs/TechRpts/2016/EECS-2016-187.html.
Chen, Minjie, Khurram K. Afridi, Sombuddha Chakraborty, and David J. Perreault. “Multitrack power conversion architecture.” IEEE Transactions on Power Electronics 32, no. 1 (2016): 325-340.
Chen, Yenan, David M. Giuliano, and Minjie Chen. “Two-stage 48v-lv hybrid switched-capacitor point-of-load converter with 24v intermediate bus.” In 2020 IEEE 21st Workshop on Control and Modeling for Power Electronics (COMPEL), pp. 1-8. IEEE, 2020.
Chen, Yenan, Hsin Cheng, David M. Giuliano, and Minjie Chen. “A 93.7% efficient 400A 48V-1V merged-two-stage hybrid switched-capacitor converter with 24V virtual intermediate bus and coupled inductors.” In 2021 IEEE Applied Power Electronics Conference and Exposition (APEC), pp. 1308-1315. IEEE, 2021.
Choi, Minho, and Deog-Kyoon Jeong. “18.6 A 92.8%-peak-efficiency 60A 48V-to-1V 3-level half-bridge DC-DC converter with balanced voltage on a flying capacitor.” In 2020 IEEE International Solid-State Circuits Conference-(ISSCC), pp. 296-298. IEEE, 2020.
Das, Ratul, and Hanh-Phuc Le. “A regulated 48V-to-1V/100A 90.9%-efficient hybrid converter for POL applications in data centers and telecommunication systems.” In 2019 IEEE Applied Power Electronics Conference and Exposition (APEC), pp. 1997-2001. IEEE, 2019.
Das, Ratul, Gab-Su Seo, and Hanh-Phuc Le. “A 120V-to-1.8 V 91.5%-efficient 36-W dual-inductor hybrid converter with natural soft-charging operations for direct extreme conversion ratios.” In 2018 IEEE Energy Conversion Congress and Exposition (ECCE), pp. 1266-1271. IEEE, 2018.
Dayerizadeh, Alireza, and Srdjan Lukic. “Saturable inductors for superior reflexive field containment in inductive power transfer systems.” In 2018 IEEE Applied Power Electronics Conference and Exposition (APEC), pp. 3183-3188. IEEE, 2018.
Elasser, Youssef, Jaeil Baek, Kaladhar Radhakrishnan, Houle Gan, Jonathan Douglas, Harish K. Krishnamurthy, Xin Li, Shuai Jiang, Charles R. Sullivan, and Minjie Chen. “Vertical Stacked 48V-1V LEGO-PoL CPU Voltage Regulator with 1A/mm 2 Current Density.” In 2022 IEEE Applied Power Electronics Conference and Exposition (APEC), pp. 1259-1266. IEEE, 2022.
Ellis, Nathan M., and Robert CN Pilawa-Podgurski. “A Symmetric Dual-Inductor Hybrid Dickson Converter for Direct 48V-to-PoL Conversion.” In 2022 IEEE Applied Power Electronics Conference and Exposition (APEC), pp. 1267-1271. IEEE, 2022.
Ellis, Nathan M., and Robert CN Pilawa-Podgurski. “Modified split-phase switching with improved fly capacitor utilization in a 48V-to-POL dual inductor hybrid-dickson converter.” In 2021 IEEE Energy Conversion Congress and Exposition (ECCE), pp. 1735-1740. IEEE, 2021.
Enhanced Intel® SpeedStep® Technology for the Intel® Pentium® M Processor, March 2004. download.intel.com/design/network/papers/30117401.pdf
Fang, Yu, Dehong Xu, Yanjun Zhang, Fengchuan Gao, Lihong Zhu, and Yi Chen. “Standby mode control circuit design of LLC resonant converter.” In 2007 IEEE Power Electronics Specialists Conference, pp. 726-730. IEEE, 2007.
Feng, Weiyi, Fred C. Lee, Paolo Mattavelli, Daocheng Huang, and Chanwit Prasantanakorn. “LLC resonant converter burst mode control with constant burst time and optimal switching pattern.” In 2011 Twenty-Sixth Annual IEEE Applied Power Electronics Conference and Exposition (APEC), pp. 6-12. IEEE, 2011. doi: 10.1109/APEC.2011.5744568.
Fiore, Alexander, Qingyun Huang, and Alex Q. Huang. “Loss Model and Output Impedance Analysis of a 48V-to-1V High Current Point-of-Load Converter.” In 2020 IEEE Energy Conversion Congress and Exposition (ECCE), pp. 938-942. IEEE, 2020.
Gong, Minxiang, Xin Zhang, and Arijit Raychowdhury. “Non-isolated 48v-to-lv heterogeneous integrated voltage converters for high performance computing in data centers.” In 2020 IEEE 63rd International Midwest Symposium on Circuits and Systems (MWSCAS), pp. 411-414. IEEE, 2020.
Jiang, Wei, Junming Zhang, Shuai Shao, Xinke Wu, and Junjun Zhang. “Constant burst frequency control for LLC converters with trajectory control.” In 2018 IEEE Energy Conversion Congress and Exposition (ECCE), pp. 6804-6808. IEEE, 2018. doi: 10.1109/ECCE.2018.8557809.
Khatua, Somnath, Debaprasad Kastha, and Santanu Kapat. “A new single-stage 48-V-input VRM topology using an isolated stacked half-bridge converter.” IEEE Transactions on Power Electronics 35, no. 11 (2020): 11976-11987.
Koli, Gauri. “Analytical Modeling and Development of GaN-Based Point of Load Buck Converter with Optimized Reverse Conduction Loss.” PhD diss., Arizona State University, 2020.
Kumar, Ashish, and Khurram K. Afridi. “Single-stage isolated 48V-to-1.8 V point-of-load converter utilizing an impedance control network for wide input range operation.” In 2017 IEEE Energy Conversion Congress and Exposition (ECCE), pp. 2003-2009. IEEE, 2017.
Kumar, Ashish, Saad Pervaiz, and Khurram K. Afridi. “High-performance single-stage isolated 48v-to-1.8 v point-of-load converter utilizing impedance control network and distributed transformer.” In 2018 IEEE Energy Conversion Congress and Exposition (ECCE), pp. 3838-3843. IEEE, 2018.
Kumar, Ashish, Saad Pervaiz, and Khurram K. Afridi. “Single-stage isolated 48V-to-1.8 V point-of-load converter utilizing an impedance control network and integrated magnetic structures.” In 2017 IEEE 18th Workshop on Control and Modeling for Power Electronics (COMPEL), pp. 1-7. IEEE, 2017.
Kwak, Jin Woong, and D. Brian Ma. “Comparative Topology and Power Loss Analysis on 48V-to-1V Direct Step-Down Non-Isolated DC-DC Switched-Mode Power Converters.” In
2020 IEEE Energy Conversion Congress and Exposition (ECCE), pp. 943-949. IEEE, 2020.

Lee, Kibok, Zeljko Pantic, and Srdjan M. Lukic. “Reflexive field containment in dynamic inductive power transfer systems.” IEEE Transactions on power Electronics 29, no. 9 (2013): 4592-4602.
Li, Yanchao, Xiaofeng Lyu, Dong Cao, Shuai Jiang, and Chenhao Nan. “A 98.55% efficiency switched-tank converter for data center application.” IEEE Transactions on Industry Applications 54, no. 6 (2018): 6205-6222.
Lin, Jing-Yuan, Pin-Hsien Liu, Hsuan-Yu Yueh, and Yi-Feng Lin. “Design and Analysis of LLC Resonant Converter with Valley Switching Control for Light-Load Conditions.” IEEE Journal of Emerging and Selected Topics in Power Electronics (2022). doi: 10.1109/JESTPE.2022.3173257.
Lou, Xin, and Qiang Li. “300A Single-stage 48V Voltage Regulator with Multiphase Current Doubler Rectifier and Integrated Transformer.” In 2022 IEEE Applied Power Electronics Conference and Exposition (APEC), pp. 1004-1010. IEEE, 2022.
Lou, Xin, Qiang Li, and Mohamed H. Ahmed. “Adaptive Voltage Positioning Design of Single Stage 48/1V Sigma Converter for Fast Transient Response.” In 2021 IEEE Energy Conversion Congress and Exposition (ECCE), pp. 3530-3536. IEEE, 2021.
Matsuura, Motoharu, Hayato Nomoto, Hikaru Mamiya, Tadanobu Higuchi, Denis Masson, and Simon Fafard. “Over 40-W electric power and optical data transmission using an optical fiber.” IEEE Transactions on Power Electronics 36, no. 4 (2020): 4532-4539. doi: 10.1109/TPEL.2013.2286104.
Ouyang, Qian, Rohan Samsi, and Jinghai Zhou. “Increasing the power density and efficacy of datacenters using a two-stage solution for 48V power distribution.” Monolithic Power Syst., San Jose, CA, USA, Tech. Rep (2017).
Seo, Gab-Su, Ratul Das, and Hanh-Phuc Le. “Dual inductor hybrid converter for point-of-load voltage regulator modules.” IEEE Transactions on Industry Applications 56, no. 1 (2019): 367-377.
Shafiei, Navid, Martin Ordonez, Marian Craciun, Chris Botting, and Murray Edington. “Burst mode elimination in high-power $ LLC $ resonant battery charger for electric vehicles.” IEEE Transactions on Power Electronics 31, no. 2 (2015): 1173-1188. doi: 10.1109/TPEL.2015.2420573.
Shi, Lin, Bangyin Liu, and Shanxu Duan. “Burst-mode and phase-shift hybrid control method of LLC converters for wide output range applications.” IEEE Transactions on Industrial Electronics 67, no. 2 (2019): 1013-1023. [17] J. Chen, T. Sato, K. Yano, H. Shiroyama, M. Owa and M. Yamadaya, “An Average Input Current Sensing Method of LLC Resonant Converters for Automatic Burst Mode Control,” in IEEE Transactions on Power Electronics, vol. 32, no. 4, pp. 3263-3272, April 2017, doi: 10.1109/TPEL.2016.2582851.
Sun, Julu, Ming Xu, Yuancheng Ren, and Fred C. Lee. “Light-load efficiency improvement for buck voltage regulators.” IEEE Transactions on Power Electronics 24, no. 3 (2009): 742-751.
Texas Instruments, “Datasheet of UCC25700: 8-Pin High-Performance Resonant Mode Controller”, March 2009.
Texas Instruments. “Using the LMG5200POLEVM-10A GaN 48V-1V point-of-load EVM.” LMG5200POLEVM-10A User's Guide (2016).
Ursino, Mario, Stefano Saggini, Shuai Jiang, and Chenhao Nan. “High density 48V-to-PoL VRM with hybrid pre-regulator and fixed-ratio buck.” In 2020 IEEE Applied Power Electronics Conference and Exposition (APEC), pp. 498-505. IEEE, 2020.
Wei, Kang, Yogesh Ramadass, and D. Brian Ma. “11.1 A Direct 12V/24V-to-1V 3 W 91.2%-Efficiency Tri-State DSD Power Converter with Online V CF Rebalancing and In-Situ Precharge Rate Regulation.” In 2020 IEEE International Solid-State Circuits Conference-(ISSCC), pp. 190-192. IEEE, 2020.
Yan, Dong, Xugang Ke, and D. Brian Ma. “A Two-Phase 2 MHz DSD GaN Power Converter with Master-Slave AO 2 T Control for Direct 48V/1V DC-DC Conversion.” In 2019 Symposium on VLSI Circuits, pp. C170-C171. IEEE, 2019.
Ye, Cikai, Pritam Das, and Sanjib Kumar Sahoo. “Peak current control of multichannel LED driver with selective dimming.” IEEE Transactions on Industrial Electronics 66, no. 5 (2018):3446-3457.
Zhao, Jun, Liang Wu, Hongyi Lin, Xiaowei Sun, and Guozhu Chen. “State trajectory control of burst mode for LCC resonant converters with capacitive output filter.” IEEE Transactions on Power Electronics 37, no. 1 (2021): 377-391. doi: 10.1109/TPEL.2021.3100539.
Zhao, Shuze, Jiale Xu, and Olivier Trescases. “Burst-mode resonant LLC converter for an LED luminaire with integrated visible light communication for smart buildings.” IEEE Transactions on Power Electronics 29, no. 8 (2013): 4392-4402.
Zhu, Jianglin, and Dragan Maksimovic. “48 V-to-1 V transformerless stacked active bridge converters with merged regulation stage.” In 2020 IEEE 21st Workshop on Control and Modeling for Power Electronics (COMPEL), pp. 1-6. IEEE, 2020.
Zhu, Yicheng, Ting Ge, Zichao Ye, and Robert CN Pilawa-Podgurski. “A Dickson-Squared Hybrid Switched-Capacitor Converter for Direct 48 V to Point-of-Load Conversion.” In 2022 IEEE Applied Power Electronics Conference and Exposition (APEC), pp. 1272-1278. IEEE, 2022.
Zhu, Yicheng, Zichao Ye, Ting Ge, Rose Abramson, and Robert CN Pilawa-Podgurski. “A Multi-Phase Cascaded Series-Parallel (CaSP) Hybrid Converter for Direct 48 V to Point-of-Load Applications.” In 2021 IEEE Energy Conversion Congress and Exposition (ECCE), pp. 1973-1980. IEEE, 2021.

AU-2003285140; AU-2004261198; AU-2005297456; AU-2010274972; AU-2012290455; AU-2013377862; AU-2014290173; AU-2015249050; AU-2019343158; AU-2019378713; AU-2020253330; AU-2021381391; BR-112016016479; BR-112020013074; BR-112020013849; CA-2352961; CA-2419000; CA-2504366; CA-2582483; CA-2768763; CA-2840058; CA-2893517; CA-2904659; CA-2918526; CA-2936847; CA-2972307; CA-2994953; CA-3014647; CA-3056408; CA-3062817; CA-3065302; CA-3066285; CA-3095382; CA-3113646; CA-3128868; CA-3134704; CN-101102377; CN-101109939; CN-101162388; CN-101494414; CN-101689070; CN-101707389; CN-101980413; CN-102368631; CN-102394510; CN-102460175; CN-102474129; CN-102545355; CN-102570573; CN-102587701; CN-102609069; CN-102622007; CN-102723449; CN-102762969; CN-102769326; CN-102769550; CN-103023131; CN-103106179; CN-103178598; CN-103257952; CN-103323789; CN-103324601; CN-103365390; CN-103577383; CN-103577384; CN-103616341; CN-103618372; CN-103630238; CN-103636094; CN-103647336; CN-103683984; CN-103730948; CN-103746365; CN-103746416; CN-103828187; CN-103887834; CN-103887862; CN-103904776; CN-103997215; CN-104037929; CN-104052032; CN-104052074; CN-104106019; CN-104333059; CN-104375069; CN-104393670; CN-104428587; CN-104578389; CN-104620469; CN-104638753; CN-104821725; CN-104904107; CN-105027020; CN-105044575; CN-105048006; CN-105098910; CN-105162179; CN-105190472; CN-105379440; CN-105449987; CN-105474496; CN-105531613; CN-105576957; CN-105811779; CN-105824385; CN-105974863; CN-106030545; CN-106095034; CN-106130058; CN-106134060; CN-106160203; CN-106161077; CN-106165276; CN-106208350; CN-106249838; CN-106252755; CN-106253718; CN-106300325; CN-106329711; CN-106329930; CN-106332499; CN-106405628; CN-106469981; CN-106505741; CN-106536924; CN-106560762; CN-106571354; CN-106712518; CN-107005147; CN-107111348; CN-107134933; CN-107179505; CN-107204235; CN-107205334; CN-107294125; CN-107343041; CN-107359377; CN-107369977; CN-107422816; CN-107465258; CN-107508321; CN-107622696; CN-107634275; CN-107689736; CN-107785992; CN-107925343; CN-108052564; CN-108073262; CN-108111016; CN-108173342; CN-108243010; CN-108281987; CN-108306409; CN-108352537; CN-108375711; CN-108471162; CN-108539840; CN-108574337; CN-108604860; CN-108604861; CN-108617141; CN-108700921; CN-108701997; CN-108702085; CN-108702086; CN-108808819; CN-108809864; CN-108811472; CN-108845658; CN-108886269; CN-109038708; CN-109062086; CN-109120414; CN-109156058; CN-109211313; CN-109215974; CN-109247081; CN-109302824; CN-109412263; CN-109586576; CN-109683108; CN-109757057; CN-109782155; CN-109786599; CN-109802391; CN-109831110; CN-109905018; CN-109958587; CN-109976502; CN-109980932; CN-110083092; CN-110086240; CN-110112905; CN-110138021; CN-110140275; CN-110176639; CN-110198127; CN-110212764; CN-110224591; CN-110460234; CN-110504836; CN-110536288; CN-110571787; CN-110618742; CN-110635559; CN-110641307; CN-110678027; CN-110678028; CN-110688337; CN-110719236; CN-110719713; CN-110729888; CN-110753473; CN-110753955; CN-110783827; CN-110794944; CN-110797967; CN-110832828; CN-110994977; CN-110998484; CN-111008174; CN-111029629; CN-111092445; CN-111094936; CN-111106648; CN-111181393; CN-111245245; CN-111315112; CN-111316085; CN-111371169; CN-111373238; CN-111404388; CN-111416334; CN-111446718; CN-111480064; CN-111488049; CN-111682752; CN-111682757; CN-111697702; CN-111697795; CN-111756243; CN-111769542; CN-111769580; CN-111769629; CN-111796599; CN-111817334; CN-111863414; CN-111864723; CN-111869075; CN-111899962; CN-111983292; CN-112003470; CN-112014697; CN-112018318; CN-112086954; CN-112117753; CN-112117911; CN-112134448; CN-112181106; CN-112186860; CN-112188788; CN-112248876; CN-112306207; CN-112311232; CN-112332466; CN-112400104; CN-112530680; CN-112557940; CN-112564078; CN-112564492; CN-112581971; CN-112615533; CN-112615534; CN-112636406; CN-112636448; CN-112653328; CN-112751619; CN-112769336; CN-112858753; CN-113012886; CN-113015417; CN-113043972; CN-113056964; CN-113097190; CN-113097988; CN-113098281; CN-113126629; CN-113130184; CN-113141003; CN-113178942; CN-113227937; CN-113314789; CN-113365477; CN-113394967; CN-113396563; CN-113436869; CN-113436870; CN-113436871; CN-113447066; CN-113451025; CN-113497486; CN-113550893; CN-113575285; CN-113589040; CN-113595165; CN-113595225; CN-113644820; CN-113647204; CN-113671418; CN-113708424; CN-113721750; CN-113726161; CN-113746331; CN-113765084; CN-113765374; CN-113767535; CN-113794373; CN-113795003; CN-113809939; CN-113829363; CN-113848940; CN-113872181; CN-113890007; CN-113890165; CN-113904389; CN-113904547; CN-113906645; CN-113921289; CN-113938017; CN-113938018; CN-113938029; CN-113946199; CN-113986809; CN-114055469; CN-114063725; CN-114071963; CN-114094594; CN-114221369; CN-114285270; CN-114326533; CN-114330619; CN-114421586; CN-114421772; CN-114454733; CN-114499191; CN-114503387; CN-114520582; CN-114531033; CN-114585215; CN-114598161; CN-114599193; CN-114624506; CN-114639576; CN-114641923; CN-114651380; CN-114665559; CN-114667673; CN-114678603; CN-114756110; CN-114765382; CN-114784789; CN-1357979; CN-1742244; CN-201075736; CN-201919006; CN-201976391; CN-202121023; CN-202126489; CN-202145578; CN-202309197; CN-202353297; CN-202423422; CN-202455149; CN-202749903; CN-202906937; CN-203275614; CN-203278378; CN-203456931; CN-203572577; CN-203720076; CN-204012681; CN-204089338; CN-204190396; CN-204425028; CN-204855688; CN-204885895; CN-204928201; CN-204945313; CN-205081511; CN-205105103; CN-205304363; CN-205316593; CN-205377445; CN-205644263; CN-205694048; CN-205725786; CN-205754365; CN-205829688; CN-205845290; CN-205959190; CN-205986178; CN-206039666; CN-206076676; CN-206099483; CN-206212530; CN-206259458; CN-206611235; CN-206647250; CN-206726034; CN-206773195; CN-207021906; CN-207124329; CN-207304780; CN-207398833; CN-207475280; CN-207588563; CN-207690946; CN-207782430; CN-207977740; CN-207994717; CN-208015396; CN-208046235; CN-208316740; CN-208445340; CN-208489801; CN-208521153; CN-208690951; CN-209013415; CN-209448232; CN-209562430; CN-209690747; CN-209692375; CN-209805833; CN-210317400; CN-210608672; CN-210717935; CN-210775747; CN-210779604; CN-211390975; CN-211405872; CN-211790953; CN-211825914; CN-211857463; CN-211959306; CN-211982034; CN-212258417; CN-212366147; CN-212435428; CN-212463052; CN-212543374; CN-212569645; CN-212646937; CN-212905488; CN-213073358; CN-213457942; CN-213461248; CN-213484906; CN-213637480; CN-213637481; CN-213934598; CN-213990277; CN-214124858; CN-214396452; CN-214708398; CN-215300255; CN-215495154; CN-215601197; CN-215642314; CN-215871193; CN-215896135; CN-215896162; CN-215896163; CN-215896164; CN-215896165; CN-216013605; CN-216310645; CN-216310777; CN-216489877; CN-216670751; CN-216699816; CN-216700790; CN-217010085; CN-217035782; CN-2671236; CN-2754251; DE-102004006529; DE-102004050665; DE-102016115433; DE-102016118409; DE-102016213559; DE-102018115319; DE-102019204385; DE-102019206267; DE-102020113122; DE-112008001665; DE-112008001665-T5; DE-112012005603-T5; DE-202017007360-U1; DE-60217154-T2; EP-0774876; EP-1131926; EP-1316017; EP-1441863; EP-1505820; EP-1556746; EP-1805881; EP-1955423; EP-2145362; EP-2317710; EP-2317711; EP-2363939; EP-2457303; EP-2641315; EP-2724439; EP-2737604; EP-2741109; EP-2755269; EP-2822145; EP-2844914; EP-2903146; EP-2926634; EP-2954695; EP-2959358; EP-2962167; EP-2974158; EP-3018793; EP-3022595; EP-3047492; EP-3095035; EP-3101794; EP-3105832; EP-3110238; EP-3118715; EP-3118716; EP-3118717; EP-3118718; EP-3127230; EP-3130051; EP-3141983; EP-3159998; EP-3169900; EP-3172494; EP-3235113; EP-3276283; EP-3282571; EP-3329534; EP-3331830; EP-3387735; EP-3414821; EP-3414822; EP-3414823; EP-3414824; EP-3414825; EP-3417354; EP-3417522; EP-3417524; EP-3428669; EP-3443648; EP-3443649; EP-3467994; EP-3518461; EP-3529951; EP-3535829; EP-3541155; EP-3616189; EP-3623902; EP-3625870; EP-3631776; EP-3639113; EP-3682537; EP-3734825; EP-3763131; EP-3764532; EP-3788769; EP-3806280; EP-3806592; EP-3809576; EP-3828555; EP-3851937; EP-3854188; EP-3879684; EP-3881658; EP-3885811; EP-3890153; EP-3893360; EP-3899691; EP-3924228; EP-3925161; EP-3928494; EP-3940939; EP-3940940; EP-3940941; EP-3942663; EP-3949067; EP-3958094; EP-3972111; EP-3986094; EP-3988948; EP-3994786; EP-4002637; EP-4009754; EP-4030601; ES-2279891-T3; ES-2378828-T3; ES-2587607-T3; ES-2750025-T3; ES-2751062-T3; ES-2754230-T3; ES-2875964-T3; ES-2897937-T3; FR-2929027; FR-2957205; FR-3107397; FR-3114457; GB-2513066; GB-2524992; GB-2566479; GB-2579126; HK-1089516; IN-2011CH02901; IN-2013MN00440; IN-2014CN01374; IN-2014CN08000; IN-2015DE03539; IN-2015KN02478; IN-201614017670; IN-201614034499; IN-201617025014; IN-201617027716; IN-201617036757; IN-201634038484; IN-201717001132; IN-201724041856; IN-201734005960; IN-201831038708; IN-201847015582; IN-201847015583; IN-201847015584; IN-201847015585; IN-201847019261; IN-201911023126; IN-201931009632; IN-201931020988; IN-201934002788; IN-202017027083; IN-202114003870; IN-202117048035; IN-202147016972; IN-202147025602; IN-328636; IN-329495; IN-363389; IN-369201; IN-370596; JP-2004334864; JP-2005184993; JP-2005502434; JP-2006505240; JP-2006506940; JP-2007049822; JP-2008519578; JP-2010049540; JP-2010136458; JP-2010147670; JP-2011004505; JP-2012005250; JP-2012143104; JP-2012209210; JP-2012209211; JP-2012210079; JP-2012210127; JP-2012248330; JP-2013033001; JP-2013038885; JP-2014521291; JP-2015122903; JP-2015139312; JP-2015159711; JP-2015162485; JP-2015181329; JP-2016105666; JP-2016192844; JP-2016515245; JP-2016515314; JP-2017028899; JP-2017513441; JP-2018136707; JP-2018185832; JP-2018514837; JP-2019051921; JP-2019175486; JP-2019505158; JP-2019510970; JP-2019511897; JP-2020120514; JP-2020188644; JP-2021022382; JP-2021523661; JP-2022003541; JP-2022058848; JP-2022501728; JP-2022504024; JP-2022515926; JP-2022527301; JP-2022530684; JP-3198574; JP-4273117; JP-4406931; JP-4847959; JP-5142972; JP-5209153; JP-5221286; JP-5283164; JP-5506559; JP-5526435; JP-5592274; JP-5687498; JP-5725548; JP-5725549; JP-5765802; JP-6008040; JP-6048572; JP-6070819; JP-6250002; JP-6343247; JP-6363113; JP-6407452; JP-6506405; JP-6534764; JP-6644906; JP-6644907; JP-6644908; JP-6644909; JP-6682652; JP-6686166; JP-6753399; JP-6787316; JP-6868031; JP-7005556; JP-WO2010082506; JP-WO2013035312; JP-WO2014132452; JP-WO2014141486; JP-WO2014141487; JP-WO2017006586; JP-WO2017006587; JP-WO2017006588; JP-WO2017094428; JP-WO2018087902; JP-WO2018087903; JP-WO2018087904; JP-WO2018087905; JP-WO2018207305; JP-WO2018207306; KR-100921682; KR-101213777; KR-101894634; KR-102069003; KR-102206706; KR-20050070113; KR-20050077978; KR-20070067724; KR-20080001241; KR-20090031087; KR-20120136811; KR-20130015526; KR-20140051147; KR-20150115813; KR-20170044011; KR-20180111971; KR-20190004669; KR-20190074994; KR-20210005681; KR-20210012961; KR-20210065967; KR-20210119384; KR-20210141716; KR-20220004718; RU-190237-U1; RU-2703290; RU-2737951; TW-200417116; TW-200931232; TW-201310850; TW-201350755; TW-201610654; TW-201625972; TW-201701115; TW-201702785; TW-201702796; TW-201711284; TW-201714394; TW-201716915; TW-201842390; TW-201901351; TW-201926850; TW-201947920; TW-202020385; TW-202037057; TW-202203545; TW-I553991; TW-I576680; TW-I614511; TW-I616617; TW-I629864; TW-I665848; TW-I693780; TW-I710203; TW-I737373; TW-I767271; U.S. Ser. No. 10/014,958; U.S. Ser. No. 10/032,553; U.S. Ser. No. 10/042,963; U.S. Ser. No. 10/063,237; U.S. Ser. No. 10/073,506; U.S. Ser. No. 10/123,450; U.S. Ser. No. 10/126,804; U.S. Ser. No. 10/128,684; U.S. Ser. No. 10/147,984; U.S. Ser. No. 10/148,192; U.S. Ser. No. 10/158,199; U.S. Ser. No. 10/164,541; U.S. Ser. No. 10/167,210; U.S. Ser. No. 10/168,753; U.S. Ser. No. 10/171,180; U.S. Ser. No. 10/188,011; U.S. Ser. No. 10/193,380; U.S. Ser. No. 10/211,733; U.S. Ser. No. 10/218,265; U.S. Ser. No. 10/263,398; U.S. Ser. No. 10/263,510; U.S. Ser. No. 10/263,530; U.S. Ser. No. 10/277,330; U.S. Ser. No. 10/310,568; U.S. Ser. No. 10/338,653; U.S. Ser. No. 10/340,788; U.S. Ser. No. 10/389,260; U.S. Ser. No. 10/389,270; U.S. Ser. No. 10/396,560; U.S. Ser. No. 10/409,349; U.S. Ser. No. 10/418,913; U.S. Ser. No. 10/439,491; U.S. Ser. No. 10/447,147; U.S. Ser. No. 10/447,148; U.S. Ser. No. 10/447,166; U.S. Ser. No. 10/454,382; U.S. Ser. No. 10/454,772; U.S. Ser. No. 10/468,965; U.S. Ser. No. 10/477,726; U.S. Ser. No. 10/502,912; U.S. Ser. No. 10/511,176; U.S. Ser. No. 10/608,549; U.S. Ser. No. 10/617,032; U.S. Ser. No. 10/624,229; U.S. Ser. No. 10/624,237; U.S. Ser. No. 10/651,741; U.S. Ser. No. 10/653,043; U.S. Ser. No. 10/657,020; U.S. Ser. No. 10/673,339; U.S. Ser. No. 10/693,312; U.S. Ser. No. 10/693,370; U.S. Ser. No. 10/694,643; U.S. Ser. No. 10/717,362; U.S. Ser. No. 10/725,514; U.S. Ser. No. 10/734,889; U.S. Ser. No. 10/749,347; U.S. Ser. No. 10/790,760; U.S. Ser. No. 10/809,775; U.S. Ser. No. 10/817,035; U.S. Ser. No. 10/819,661; U.S. Ser. No. 10/826,250; U.S. Ser. No. 10/845,853; U.S. Ser. No. 10/855,106; U.S. Ser. No. 10/855,381; U.S. Ser. No. 10/871,963; U.S. Ser. No. 10/877,534; U.S. Ser. No. 10/879,791; U.S. Ser. No. 10/879,813; U.S. Ser. No. 10/881,017; U.S. Ser. No. 10/892,686; U.S. Ser. No. 10/897,839; U.S. Ser. No. 10/932,388; U.S. Ser. No. 10/944,219; U.S. Ser. No. 10/958,098; U.S. Ser. No. 10/969,842; U.S. Ser. No. 10/989,762; U.S. Ser. No. 11/005,379; U.S. Ser. No. 11/013,143; U.S. Ser. No. 11/013,144; U.S. Ser. No. 11/032,089; U.S. Ser. No. 11/043,899; U.S. Ser. No. 11/043,900; U.S. Ser. No. 11/044,165; U.S. Ser. No. 11/058,029; U.S. Ser. No. 11/081,963; U.S. Ser. No. 11/102,912; U.S. Ser. No. 11/108,266; U.S. Ser. No. 11/126,255; U.S. Ser. No. 11/129,298; U.S. Ser. No. 11/135,923; U.S. Ser. No. 11/146,866; U.S. Ser. No. 11/151,827; U.S. Ser. No. 11/152,853; U.S. Ser. No. 11/152,854; U.S. Ser. No. 11/165,511; U.S. Ser. No. 11/182,143; U.S. Ser. No. 11/196,291; U.S. Ser. No. 11/208,337; U.S. Ser. No. 11/215,776; U.S. Ser. No. 11/233,860; U.S. Ser. No. 11/271,396; U.S. Ser. No. 11/277,912; U.S. Ser. No. 11/277,938; U.S. Ser. No. 11/281,278; U.S. Ser. No. 11/284,532; U.S. Ser. No. 11/290,008; U.S. Ser. No. 11/294,254; U.S. Ser. No. 11/334,103; U.S. Ser. No. 11/342,788; U.S. Ser. No. 11/357,131; U.S. Ser. No. 11/362,540; U.S. Ser. No. 11/362,585; U.S. Ser. No. 11/368,092; U.S. Ser. No. 11/372,180; U.S. Ser. No. 11/394,294; US-20020019958; US-20030051886; US-20030074463; US-20030084357; US-20030084358; US-20030084359; US-20030179874; US-20040006255; US-20040022237; US-20040150374; US-20040221084; US-20040230866; US-20050071690; US-20050071691; US-20050219825; US-20060097578; US-20060196681; US-20060220464; US-20060284489; US-20070046103; US-20070052294; US-20070081315; US-20070121277; US-20070286411; US-20080013531; US-20080025294; US-20080025295; US-20080123297; US-20080312853; US-20080320322; US-20090034522; US-20090046484; US-20090056359; US-20090091191; US-20090174256; US-20090179487; US-20090216910; US-20100008038; US-20100165565; US-20100209058; US-20100246233; US-20100302754; US-20110013348; US-20110018342; US-20110166824; US-20110288798; US-20110292703; US-20120013186; US-20120127656; US-20120134104; US-20120140415; US-20120147552; US-20120173894; US-20120177195; US-20120194146; US-20120210416; US-20120326504; US-20120326516; US-20120326653; US-20120327592; US-20130017955; US-20130020872; US-20130026836; US-20130058377; US-20130062954; US-20130070757; US-20130154365; US-20130187460; US-20130190936; US-20130193764; US-20130194726; US-20130198532; US-20130198533; US-20130198534; US-20130273445; US-20130306276; US-20130313892; US-20130335043; US-20140059510; US-20140070611; US-20140095107; US-20140101462; US-20140175293; US-20140192456; US-20140201090; US-20140219656; US-20140239718; US-20140240909; US-20140240914; US-20140244881; US-20140244886; US-20140258738; US-20140268943; US-20140317315; US-20140325636; US-20150001942; US-20150002107; US-20150011152; US-20150030323; US-20150078740; US-20150121113; US-20150130279; US-20150130352; US-20150131270; US-20150143140; US-20150171663; US-20150180232; US-20150180233; US-20150194842; US-20150207318; US-20150207424; US-20150222193; US-20150254381; US-20150289405; US-20150309271; US-20150327406; US-20150344335; US-20150357865; US-20150372462; US-20160006247; US-20160006299; US-20160016829; US-20160020669; US-20160020858; US-20160020911; US-20160062428; US-20160065056; US-20160066066; US-20160078054; US-20160087443; US-20160087938; US-20160094089; US-20160107905; US-20160109916; US-20160134160; US-20160156182; US-20160165744; US-20160182450; US-20160195580; US-20160204654; US-20160209887; US-20160211632; US-20160248631; US-20160251240; US-20160275034; US-20160276942; US-20160294866; US-20160345459; US-20160359427; US-20160381823; US-20170012442; US-20170024295; US-20170025956; US-20170025961; US-20170033337; US-20170033338; US-20170033408; US-20170054368; US-20170063220; US-20170088446; US-20170096352; US-20170097674; US-20170104410; US-20170117709; US-20170117810; US-20170117971; US-20170126054; US-20170133944; US-20170141695; US-20170149180; US-20170163573; US-20170164500; US-20170179817; US-20170184799; US-20170187468; US-20170187469; US-20170237261; US-20170242467; US-20170242469; US-20170271073; US-20170279170; US-20170294835; US-20170300100; US-20170313603; US-20170332510; US-20170339804; US-20180009323; US-20180026518; US-20180026640; US-20180076718; US-20180107258; US-20180107470; US-20180107476; US-20180219635; US-20180232026; US-20180233885; US-20180241315; US-20180349247; US-20180351307; US-20180364312; US-20180372974; US-20190006940; US-20190044370; US-20190044372; US-20190044432; US-20190044433; US-20190044434; US-20190058415; US-20190077401; US-20190081565; US-20190089254; US-20190097542; US-20190103641; US-20190109539; US-20190199232; US-20190199448; US-20190218118; US-20190235590; US-20190237916; US-20190297749; US-20190310697; US-20190317570; US-20190356159; US-20190357384; US-20190393789; US-20200007032; US-20200076700; US-20200089293; US-20200093024; US-20200093025; US-20200093026; US-20200093032; US-20200093037; US-20200093038; US-20200099302; US-20200099311; US-20200100380; US-20200120831; US-20200137466; US-20200150508; US-20200153331; US-20200205309; US-20200209497; US-20200212795; US-20200212807; US-20200220466; US-20200251995; US-20200313445; US-20200313550; US-20200328676; US-20200343040; US-20200350768; US-20200359496; US-20200366091; US-20200376979; US-20200381937; US-20200395781; US-20200396855; US-20210005378; US-20210006095; US-20210014783; US-20210022263; US-20210026428; US-20210041924; US-20210063836; US-20210066957; US-20210081013; US-20210104764; US-20210104910; US-20210111717; US-20210111910; US-20210111911; US-20210119546; US-20210120705; US-20210140935; US-20210159782; US-20210159788; US-20210167974; US-20210167975; US-20210183846; US-20210194188; US-20210212193; US-20210239927; US-20210242786; US-20210274677; US-20210287469; US-20210288576; US-20210288581; US-20210316621; US-20210316637; US-20210343993; US-20210359504; US-20220004241; US-20220006386; US-20220014032; US-20220014086; US-20220014109; US-20220014110; US-20220030332; US-20220045628; US-20220052767; US-20220057823; US-20220060012; US-20220072968; US-20220087048; US-20220094350; US-20220097559; US-20220103066; US-20220103088; US-20220131471; US-20220158458; US-20220161668; US-20220165113; US-20220166314; US-20220172880; US-20220179275; US-20220190619; US-20220196948; US-20220200334; US-20220210715; US-20220219549; US-20220224231; U.S. Pat. Nos. 5,280,625; 6,614,781; 6,625,651; 6,732,167; 6,761,679; 6,813,278; 6,836,803; 6,895,528; 6,957,353; 6,961,778; 6,984,965; 7,043,650; 7,090,028; 7,133,287; 7,141,893; 7,141,894; 7,203,846; 7,222,246; 7,272,733; 7,281,076; 7,315,456; 7,394,169; 7,462,954; 7,492,057; 7,564,840; 7,564,961; 7,633,181; 7,895,455; 7,970,560; 7,990,710; 8,014,518; 8,036,214; 8,085,761; 8,089,958; 8,138,635; 8,270,421; 8,311,753; 8,344,546; 8,358,508; 8,415,831; 8,423,103; 8,466,663; 8,504,314; 8,606,540; 8,693,347; 8,706,914; 8,706,915; 8,708,736; 8,723,362; 8,737,079; 8,750,006; 8,776,207; 8,833,094; 8,842,420; 8,842,430; 8,957,542; 8,963,371; 8,972,752; 8,994,339; 9,024,262; 9,030,843; 9,037,443; 9,043,002; 9,059,600; 9,116,536; 9,116,692; 9,141,164; 9,143,392; 9,148,068; 9,157,735; 9,164,557; 9,172,219; 9,203,238; 9,214,812; 9,229,504; 9,237,132; 9,252,598; 9,256,565; 9,261,922; 9,268,730; 9,270,089; 9,276,907; 9,281,717; 9,301,420; 9,318,761; 9,320,166; 9,335,774; 9,335,786; 9,368,954; 9,377,832; 9,379,579; 9,379,628; 9,389,666; 9,413,221; 9,416,032; 9,431,917; 9,438,012; 9,455,956; 9,460,110; 9,462,724; 9,481,587; 9,481,588; 9,490,720; 9,507,113; 9,520,747; 9,520,772; 9,537,409; 9,557,505; 9,559,516; 9,578,401; 9,642,282; 9,652,343; 9,661,777; 9,670,078; 9,673,625; 9,678,544; 9,680,188; 9,681,587; 9,685,881; 9,708,205; 9,712,073; 9,712,337; 9,719,673; 9,753,881; 9,774,263; 9,793,754; 9,794,651; 9,812,925; U.S. Pat. Nos. 9,819,060; 9,819,263; 9,831,776; 9,882,422; 9,882,656; 9,891,700; 9,893,521; 9,899,835; 9,912,015; 9,915,992; 9,923,474; 9,936,603; 9,954,369; 9,968,008; 9,973,077; 9,977,208; 9,977,476; 9,991,740; WO-2000031933; WO-2002013013; WO-2004040956; WO-2006042513; WO-2006107442; WO-2007044872; WO-2007064485; WO-2008131446; WO-2008157574; WO-2009002383; WO-2010082506; WO-2011011125; WO-2012074743; WO-2012113807; WO-2012113808; WO-2012132151; WO-2013003357; WO-2013018825; WO-2013019549; WO-2013035312; WO-2013059961; WO-2013115784; WO-2013165694; WO-2014012120; WO-2014040529; WO-2014086771; WO-2014123638; WO-2014127870; WO-2014132452; WO-2014134345; WO-2014134914; WO-2014141486; WO-2014141487; WO-2014164036; WO-2015009713; WO-2015013462; WO-2015042366; WO-2015066048; WO-2015109193; WO-2015120619; WO-2015152920; WO-2015155203; WO-2015157600; WO-2016010941; WO-2016099355; WO-2016123879; WO-2016169246; WO-2016206089; WO-2017006586; WO-2017006587; WO-2017006588; WO-2017015670; WO-2017023869; WO-2017024196; WO-2017067645; WO-2017094428; WO-2017096173; WO-2017117096; WO-2017131722; WO-2017137336; WO-2017137342; WO-2017137352; WO-2017137389; WO-2017137406; WO-2017137430; WO-2017142905; WO-2017143205; WO-2017143216; WO-2017152823; WO-2017157204; WO-2017161035; WO-2017178477; WO-2017178478; WO-2017210279; WO-2018075982; WO-2018083332; WO-2018087902; WO-2018087903; WO-2018087904; WO-2018087905; WO-2018200740; WO-2018210917; WO-2018222695; WO-2018231932; WO-2019020017; WO-2019034949; WO-2019052880; WO-2019173094; WO-2019184962; WO-2019199439; WO-2019210632; WO-2019210718; WO-2019210719; WO-2019210720; WO-2019213441; WO-2020011255; WO-2020019990; WO-2020020253; WO-2020061305; WO-2020102090; WO-2020131758; WO-2020134214; WO-2020164757; WO-2020165255; WO-2020171886; WO-2020192205; WO-2020193067; WO-2020205574; WO-2020206270; WO-2020221590; WO-2021003347; WO-2021004828; WO-2021017563; WO-2021043173; WO-2021072429; WO-2021081144; WO-2021150271; WO-2021175215; WO-2021185099; WO-2021211630; WO-2021211635; WO-2021211682; WO-2021231759; WO-2021233170; WO-2021241919; WO-2022000473; WO-2022001834; WO-2022012427; WO-2022028116; WO-2022062425; WO-2022067192; WO-2022067198; WO-2022072330; WO-2022072658; WO-2022109251; WO-2022109416; WO-2022109983; WO-2022126224; and WO-2022155266.

Each of the foregoing reference is expressly incorporated herein by reference in its entirety.

### SUMMARY OF THE INVENTION

In contrast to all the above discussed solutions, the present technology provides a single-stage half-bridge inductive-link converter to step down high input voltage with low switch count.

Galvanic isolation is achieved using a high frequency transformer with a primary side half-bridge and a secondary side synchronous rectifier (SR) with a capacitive filter, achieved without impairing power density. Also, to accommodate high slew rate dynamics at the load end, a quasi-peak cycle-by-cycle peak current control is incorporated. Unlike Pulse Width Modulated converters, but similar to resonant converters, this converter offers soft-switching operation.

The transformer is, for example, a 16:1:1 transformer with copper windings (which may be wire or a planar transformer having printed circuit windings, for example.

Each of the switches may be a MOSFET switch, a MOSFET switch in parallel with a diode, or a SiC MOSFET with or without external diode. Other types of switches may be used, such as GaN, Si, etc. Generally, SiC is useful for high voltage switching, and is not required herein.

The circuit architecture for the Point of Load converter is shown in the FIG. 1. The circuit consists of a half-bridge (HB) converter followed by an inductor to feed AC input to high frequency transformer, and then a synchronous rectifier to rectify the AC output to desired DC output. Power is transferred by energizing and deenergizing of the inductor. Two DC link capacitors are connected in series across the input voltage. During steady state, both the voltages across both capacitors are the same. On the secondary side, a capacitor is connected to filtered out the AC current ripple of the rectified current. The current through the inductor and the voltage across the primary winding corresponding to different gate pulses fed to the switches are presented in the FIG. 2.

The present technology provides an inductive link input side half-bridge and output side synchronous-rectifier to achieve high step down of input voltage at output end. A ratio of 48:1 or higher is possible, e.g., 48 V to less than 1 V. A simple circuit configuration with a smaller number of switches of the converter makes it potentially lower in cost and smaller in size than traditional designs.

The present technology provides a high step-down transformer which is integrated to accomplish high step down of input voltage with only capacitive filter required at the output end.

The high step-down transformer allows implementation of lower current carrying devices at the primary side, on top of galvanic isolation between the input and output side. Only capacitive filtering at the output helps in reduction of overall filter size space requirement, as an inductive filter for the high current application would take more real estate on the circuit board. Note that more complex filters may be employed as appropriate.

The present technology further provides a peak current controller incorporated to realize quasi cycle by cycle control, using a mixture of analog and digital components and two sensors. By doing this, high slew rate load transients demand is achieved by sensing only the output voltage and a low AC inductor current of the inductive link. Sensing only the small AC current is not only cost effective but also occupies smaller space on printed circuit board.

In place of an inductor, a saturable reactor is introduced to reduce operating frequency range of the converter. Stringent high efficiency requirements for the point of load applications at light load is accomplished without incorporating any complexities in control, or adding any extra circuit components to the converter.

The present technology provides a DC current sensor-less droop control in both burst mode control and peak current control. No extra sensor is used to sense the load side current to implement droop control. Load demand current is calculated internally through the proportional-integral controller. Droop control minimizes interaction between the burst controller and the peak current controller during full load to very light load and vice versa load transients with high slew rate. Together these form an automatic voltage positioning (AVP) control to achieve a reduction of output capacitance requirements during very high step change in output load demand.

A Proportional Integral (PI) implements a control based on the level of a control variable, an integral of the control variable, and therefore encompasses first order effects. A variation of Proportional Integral (PI) control uses only the proportional and integral terms as a proportion-integral control. The value of the controller output u(t) is fed into the system as the manipulated variable input.

$$e ( t ) = SP - PV$$

$$u ( t ) = {u}_{bias} + {K}_{c} e ( t ) + \frac{{K}_{c}}{{τ}_{I}} {\int }_{0}^{t} e ( t ) dt$$

The u_{bias} term is a constant that is typically set to the value of u(t) when the controller is first switched from manual to automatic mode. This gives “bumpless” transfer if the error is zero when the controller is turned on. The two tuning values for a proportional-integral controller are the controller gain, K_{c} and the integral time constant τ_{I}. The value of K_{c} is a multiplier on the proportional error and integral term and a higher value makes the controller more aggressive at responding to errors away from the set point. The set point (SP) is the target value and process variable (PV) is the measured value that may deviate from the desired value. The error from the set point is the difference between the SP and PV and is defined as e(t)=SP−PV.

Digital controllers are implemented with discrete sampling periods and a discrete form of the proportional-integral equation is needed to approximate the integral of the error. This modification replaces the continuous form of the integral with a summation of the error and uses Δt as the time between sampling instances and nₜ as the number of sampling instances.

$$u ( t ) = {u}_{bias} + {K}_{c} e ( t ) + \frac{{K}_{c}}{{τ}_{I}} {\sum }_{i = 1}^{{n}_{t}} {e}_{i} ( t ) Δ t$$

See, apmonitor.com/pdc/index.php/Main/ProportionalIntegralControl

A proportional-integral-differential (P-I-D) controller adds a differential operator input to the P-I controller.
u(t)=Kₚe(t)+Ki
∫e(t)dt+Kₚ de/dt
u(t)=PID control variable
Kₚ=proportional gain
e(t)=error value
Kᵢ=integral gain
de=change in error value
dt=change in time

The burst mode controller may be realized digitally for operation at light load conditions, which necessitates no extra circuit component to the converter.

Zero Voltage Switching operation is achieved in the primary side and Zero Current Switching is attained in the secondary side.

Soft Switching is the most general term and includes both zero voltage and zero current switching, the latter done typically at turn off. Soft switching can also indicate switching the MOSFET on with low voltage across drain and source, not necessarily zero. This is sometimes referred to as quasi resonant switching. Two examples are quasi resonant flyback and PFC, where the MOSFET is turned on during the parasitic resonance that follows the inductor current hitting zero. Quasi resonance typically involves critical conduction mode and variable frequency operation.

Resonant Switching can happen between the parasitic elements in the circuit, such as leakage inductances and C_{OSS} of the MOSFET being turned on, or among the main components of the power train itself, as in LLC converters. In the former case, the operating frequency is constant. The power train may be the same as in a hard switched operation or have additional low power elements to facilitate ZVS. The switching sequence is manipulated by the control circuit to achieve zero voltage turn on. The latter case, where resonance is achieved among the non-parasitic elements of the circuit, requires variable frequency operation. The switching frequency must be set above the natural resonance of the circuit to present an inductive load. This ensures that the current is negative at the zero crossover of the fundamental component of the applied voltage. Resonance is a common technique for achieving ZVS, but not the only one.

Synchronous Switching refers to a class of converters where a MOSFET replaces a rectifier. The circuits were originally conceived and work normally with rectifiers, which have been replaced by MOSFETs to reduce the forward drop. Examples are synchronous buck, synchronous boost, and secondary synchronous rectifiers. Though not usually perceived as examples of zero voltage switching, ZVS of the synchronous switch is an inherent feature of these topologies. They operate at fixed frequency, do not need any resonance, and the MOSFETS conduct entirely in the third quadrant.

A fundamental limitation of zero voltage switching is that it reduces switching losses only at turn on. The crossover losses at turn off continue to be incurred. Ideally, turn on should be at zero voltage and turn off at zero current to eliminate all switching losses.

Another switching loss at turn on comes from the energy stored in C_{OSS}. If a MOSFET is hard switched at a frequency F_{SW}, the stored energy E_{OSS} in the output capacitor is discharged into the channel, causing a power loss of E_{OSS}×F_{SW}. With zero voltage switching, this energy is delivered either to the load or the input and not lost. However, ZVS does not eliminate all the losses associated with E_{OSS}. There is a loss in the circuit associated with charging of the C_{OSS} capacitor as well. Havanur, Sanjay, “Beware of Zero Voltage Switching”, Vishay Siliconix www.mouser.com/pdfdocs/Vishay_Zero_Voltage_Switching.pdf.

Vishay Application Note AN-849 “Power MOSFET Basics: Understanding Superjunction Technology” www.vishay.com/docs/66864/an849.pdf

Saro, Leo; Kenneth Dierberger and Richard Red1 “High-Voltage MOSFET Behavior in Soft-Switching Converters: Analysis and Reliability Improvements” Twentieth International Telecommunications Energy Conference, IEEE INTELEC. 1998, pp 30-40.

Polenov et al, “The Influence of Turn-Off Dead Time on the Reverse-Recovery Behaviour of Synchronous Rectifiers in Automotive DC/DC-Converters”, EPE '09, 13th European Conference on Power Electronics and Applications, 2009.

In order to avoid the losses caused by hard-switching transitions of MOSFETs, ZVS is commonly applied. This requires the presence of an impressed current of an inductive component which charges/discharges the output capacitances of the MOSFETs within a bridge leg during the interlocking time of the associated gate signals. In order to determine whether ZVS is provided at a given operating point, the stored charge within the MOSFETs has to be considered and the conditionLI²≥2QₒₛₛV_{DC} has to be fulfilled. In the case of incomplete soft switching, nonzero losses occur.

Kasper, Matthias, Ralph M. Burkart, Gerald Deboy, and Johann W. Kolar. “ZVS of power MOSFETs revisited.” IEEE Transactions on Power Electronics 31, no. 12 (2016): 8063-8067.

Reduction of operating frequency range aids in thermal management of magnetic components. Restriction of highest frequency at a fixed point, in spite of input voltage variation as well as load demand changes contributes in feasible magnetic design.

The present technology may be used to provide high-step down low voltage high current for server application, telecom application, and new age GPU (Graphics Processing unit) application. A key feature is the ability to respond to very fast load transients.

It is an object to provide a DC-DC converter, comprising: a half-bridge stage, comprising a first pair of switches, configured to receive DC power and generate therefrom an oscillating waveform in a transformer circuit comprising an inductance, the oscillating waveform being associated with an inductor current; a synchronous rectifier stage, comprising a second pair of switches, configured to produce a rectified output voltage from power transferred through the transformer circuit; and a controller, producing switch control signals, configured to: operate the first pair of switches in a soft switching mode to produce the oscillating waveform having a switching rate dependent on the rectified output voltage and a switching duty cycle dependent on the inductor current; and synchronously operate the second pair of switches to produce the rectified output voltage.

It is another object to provide a converter, comprising: a transformer circuit, having a series inductor; a half-bridge stage, comprising a first pair of switches, configured to receive electrical power and generate therefrom an oscillating waveform of an inductor current in the series inductor of the transformer circuit; a synchronous rectifier stage, comprising a second pair of switches, configured to produce a rectified output from power transferred through the transformer circuit from the half-bridge stage; and a controller, configured to produce switch control signals, which: operate the first pair of switches in a soft switching mode to produce the oscillating waveform having a switching rate dependent on the rectified output of the synchronous rectifier stage, and a switching duty cycle dependent on the inductor current; and synchronously operate the second pair of switches to produce the rectified output.

A further object provides a method of operating a converter, comprising a first pair of switches at an input of a transformer circuit with a series inductor, configured to receive electrical power and to generate therefrom an oscillating waveform of an inductor current in the transformer circuit, and a second pair of switches at an output of the transformer circuit implementing a synchronous rectifier configured to produce a rectified output from power transferred through the transformer circuit, the method comprising: controlling the first pair of switches in a soft switching mode to produce the oscillating waveform having a switching rate dependent on the rectified output and a switching duty cycle dependent on the series inductor current; and controlling the second pair of switches to synchronously rectify the power transferred through the transformer circuit corresponding to the oscillating waveform to produce the rectified output. The first set of switches may be zero voltage switched and the second set of switches may be zero current switched, and the converter may have at least one mode of operation in which a switching rate of the first pair of switches is controlled dependent on feedback representing a level of the rectified output, and a switching duty cycle of the first pair of switches is controlled dependent on a threshold level of the inductor current.

It is another object to provide a controller for a voltage converter, comprising an input stage comprising at least one first pair of switches, configured to receive electrical power and generate therefrom an oscillating waveform, and at least one second pair of switches configured to synchronously rectify a product of the oscillating waveform coupled through a transformer circuit having an inductor current passing through a series inductor, the controller comprising at least a proportional and integral processor comprising a negative feedback input corresponding to the synchronously rectified product, and being configured to produce switching waveforms for the at least one first pair of switches having a rate responsive to the negative feedback and a pulse width responsive to an inductor current driven by the at least one first pair of switches, and synchronous rectification switching waveforms for the second pair of switches. The controller may be provided with the transformer circuit, having the series inductor.

The controller may be configured to receive feedback representing a level of the rectified output voltage and to control the switching rate to maintain the voltage of the rectified output voltage at a desired level.

As referred to herein, a value is maintained if it varied less than ±10% from a nominal value over time, though stricter requirements may be imposed, i.e., less than ±5% variation, or lower.

The controller may be configured to receive feedback representing the inductor current and to control the switching duty cycle in dependence thereon.

The first set of switches may be zero voltage switched.

The second set of switches may be zero current switched.

The first set of switches may be galvanically isolated from the second set of switches.

The DC power may be received at 48 V and the rectified output voltage is less than 1.5, 1.4, 1.3, 1.2, 1.1, 1.0, 0.95. 0.90, 0.85, 0.80, 0.75, 0.70, 0.65, 0.60, 0.55, 0.50, 0.45, 0.40, 0.35, 0.30, or 0.25 VDC.

The DC-DC converter may further comprise an output filter. The output filter may comprise a capacitor in parallel with a load.

The transformer circuit may comprise a center-tapped transformer. The center-tapped transformer may have winding ratios of 16:1:1.

The first and/or second pair of switches may be MOSFETs.

The transformer circuit may comprise a transformer winding in series with an inductor. The transformer circuit may comprise a transformer winding in series with a saturable inductor.

The series inductor may comprise a saturable inductor in series with a transformer winding, and the half-bridge stage may be configured to generate the oscillating waveform of the inductor current in the saturable inductor in series with the transformer winding.

The DC-DC converter may further comprise a pair of capacitors in series across the DC power, having a static node between the capacitors, and the pair of switches may be provided in series across the DC power having a dynamic node between the switches, wherein a primary of the transformer circuit is connected between the static node and the dynamic node.

The primary of the transformer circuit may comprise a transformer winding in series with an inductor. The primary of the transformer circuit may comprise a transformer winding in series with a saturable inductor.

The saturable inductor may have an inductance characteristic adapted to maintain an operating frequency of the first pair of switches below 1 MHz.

The controller may be a proportional-integral controller or a proportional-integral-differential controller.

The controller may be configured to perform quasi-peak cycle-by-cycle peak current control.

The control may comprise a droop control.

The control may comprise a sensor-less droop control configured to calculate load demand current through a proportional-integral control algorithm.

The control may comprise a sensor-less droop control configured to calculate load demand current and perform quasi-peak cycle-by-cycle peak current control through a proportional-integral or proportional-integral-differential control algorithm.

The control may be configured to minimize interaction between a droop control and a peak current control over a range of loads.

The control may comprise a droop control and a peak current control, configured to maintain the rectified output voltage within a predetermined range.

The control may comprise a droop control and a peak current control, further comprising an output filter having a time constant, wherein the control may be configured to maintain the rectified output voltage within a predetermined range over a period greater than the time constant.

The DC-DC converter may comprise a capacitor having a capacitance adapted to maintain the rectified output voltage within a predetermined range over a period, wherein the control may comprise a droop control and a peak current control configured to maintain the rectified output voltage within the predetermined range longer than the period.

The controller may be configured to provide a burst mode to improve efficiency of operation of the DC-DC converter under light load conditions.

The burst mode may be implemented using digital logic.

The controller may be configured to operate the first pair of switches in the soft switching mode to produce the oscillating waveform having the switching rate dependent on negative feedback of a magnitude of the rectified output voltage and a switching duty cycle dependent on comparison of a magnitude of the inductor current with a reference peak current.

The controller may comprise a first processor configured to process a signal according to a load gain and a second processor configured to process a signal according to a droop gain.

The controller may have a gain G(s)=G₁(s)•G₂(s) comprising a load gain

$${G}_{1} ( s ) = \frac{( s )}{( s )}$$

and a droop gain

$${G}_{2} ( s ) = \frac{( s )}{} ,$$

wherein G₁(s) is responsive to a peak of the inductor current, while G₂(s) is responsive to the rectified output voltage.

The controller may be configured to generate one pulse of fixed frequency with a duty cycle varying according to a peak reference value, and low pass filtering the one pulse to generate the peak reference value.

The control may be configured to compare the generated peak reference value with the inductor current to control the duty cycle.

The control may comprise an AND gate functionality, configured to determine a conjunction of a peak detector pulse derived from the inductor current and a level detector output dependent on a relation of a reference voltage and the rectified output voltage.

A small signal transfer function of the control may correspond to

$$G ( s ) = \frac{( s )}{( s )} ,$$

wherein V₀ is the rectified output voltage and Iₚₖ can is a peak inductor current.

The oscillating waveform may have a frequency between 150 kHz and 400 kHz at full load, and between 900 kHz and 1,500 kHz at 20% load.

The oscillating waveform may have a frequency of 250 kHz at full load, and 1,350 kHz at 20% load.

The transformer circuit may comprise a saturable inductor configured to offer a progressively increasing inductance as a load operating on the rectified output voltage may be reduced.

It is also an object to provide a method of operating a DC-DC converter having a half-bridge stage, comprising a first pair of switches, configured to receive DC power and generate therefrom an oscillating waveform in a transformer circuit comprising an inductance, the oscillating waveform being associated with an inductor current and a synchronous rectifier stage, comprising a second pair of switches, configured to produce a rectified output voltage from power transferred through the transformer circuit, the method comprising: controlling the first pair of switches in a soft switching mode to produce the oscillating waveform having a switching rate dependent on the rectified output voltage and a switching duty cycle dependent on the inductor current; and controlling the second pair of switches to produce the synchronously rectify the oscillating waveform pass through the transformer circuit to produce the rectified output voltage.

The switching rate of the first pair of switches may be controlled dependent on feedback representing a level of the rectified output voltage.

The switching duty cycle of the first pair of switches may be controlled dependent on a threshold level of the inductor current.

The first set of switches may be zero voltage switched. The second set of switches may be zero current switched.

The first set of switches may be controlled with a proportional-integral-differential controller or a proportional-integral controller.

The proportional-integral controller may be configured to perform quasi-peak cycle-by-cycle peak current control.

The controller may perform a droop compensation.

The controller may perform sensor-less droop compensation to calculate load demand current.

The method may further comprise minimizing interaction between a droop control and a peak current control over a range of loads.

The controller may implement droop control and peak current control, to maintain the rectified output voltage within a predetermined range.

The controller may implement droop control and peak current control, further comprising providing an output filter having a time constant, wherein the controller maintains the rectified output voltage within a predetermined range over a period greater than the time constant.

The DC-DC converter further may comprise a capacitor having a capacitance adapted to maintain the rectified output voltage subject to a load within a predetermined range during a period, wherein the controller implements droop control and peak current control, to maintain the rectified output voltage within the predetermined range longer than the period.

The controller may process a signal according to a load gain and a droop gain.

The controller may have a gain G(s)=G₁(s)•G₂(s) comprising a load gain

$${G}_{1} ( s ) = \frac{( s )}{( s )}$$

and a droop gain

$${G}_{2} ( s ) = \frac{( s )}{( s )} ,$$

w herein G₁(s) is responsive to a peak of the inductor current, while G₂(s) is responsive to the rectified output voltage.

The controller may generate one pulse of fixed frequency with a duty cycle varying according to a peak reference value, and low pass filters the one pulse to generate the peak reference value.

The controller may compare the generated peak reference value with the inductor current to control the duty cycle.

The controller may provide a burst mode to improve efficiency of operation of the DC-DC converter under light load conditions.

The controller may operate the first pair of switches in the soft switching mode to produce the oscillating waveform having the switching rate dependent on negative feedback of a magnitude of the rectified output voltage and a switching duty cycle dependent on comparison of a magnitude of the inductor current with a reference peak current.

The pair of first switches may be controlled according to an AND gate functionality, which determines a conjunction of a peak detector pulse derived from the inductor current and a level detector output dependent on a relation of a reference voltage and the rectified output voltage.

The first set of switches may be controlled according to a small signal transfer function corresponding to

$$G ( s ) = \frac{( s )}{( s )} ,$$

wherein V₀ is the rectified output voltage and Iₚₖ can is a peak inductor current.

The transformer circuit may comprise a saturable inductor configured to offer a progressively increasing inductance as a load operating on the rectified output voltage may be reduced.

It is a still further object to provide a controller for a DC-DC converter, the DC-DC converter having an input stage comprising at least one first pair of switches, configured to receive DC power and generate therefrom an oscillating waveform and at least one second pair of switches configured to synchronously rectify a product of the oscillating waveform, the controller comprising negative feedback input corresponding to the synchronously rectified product, and at least a proportional and integral processor, the controller being configured to produce switching waveforms for the at least one first pair of switches having a rate responsive to the negative feedback and a pulse width responsive to an inductor current driven by the at least one first pair of switches.

The controller may be further configured to produce switching waveforms to synchronously switch the at least one second pair of switches.

It is a still further object to provide a DC to DC converter, comprising: a half-bridge stage, comprising a first pair of switches, configured to receive 48 V power and generate therefrom an oscillating waveform having a frequency between 100 kHz and 1 MHz or 2 MHz in a transformer circuit comprising an inductance which declines with increasing frequency, the oscillating waveform being associated with an inductor current; a synchronous rectifier stage, comprising a second pair of switches, configured to produce a regulated rectified output voltage from power transferred through the transformer circuit; and a controller, producing switch control signals, configured to: operate the first pair of switches in a soft switching mode to produce the oscillating waveform having a switching rate dependent on the regulated rectified output voltage and a switching duty cycle dependent on the inductor current; and synchronously operate the second pair of switches to produce the regulated rectified output voltage.

The regulated rectified output voltage may be less than 5%, 4%, 3%, 2.5%, 2.3%, 2.2%, 2.1%, 2.0%, 1.9%, 1.8%, 1.7%, 1.6%, 1.5%, 1.4%, 1.3%, 1.2%, 1.1%, 1%, 0.9%, 0.8%, 0.7%. 0.6%, Or 0.5% of the received 48 V power.

### BRIEF DESCRIPTION OF THE DRAWINGS

FIG. 1 shows a schematic diagram of a circuit according to the present invention.

FIG. 2 shows waveforms of inductor current and different voltages corresponding to gate pulses.

FIG. 3 shows a control block diagram for converter.

FIG. 4 shows synthesis of a gate for a half-bridge converter.

FIG. 5 show switching frequency of a half-bridge converter under load.

FIG. 6 shows variation in inductance value with load current.

FIG. 7 show the switching frequency of converter with load due to saturable reactor FIG. 8 shows waveforms of saturable inductor current and different voltages corresponding to gate pulses.

FIG. 9 show a train of gate pulses for half-bridge converter with a burst mode controller.

FIG. 10 shows synthesis of gate pulses for half-bridge converter with a burst mode controller.

FIG. 11 shows application of droop control in synthesizing peak current reference.

FIG. 12 shows application of droop control in a burst mode controller.

FIG. 13 shows a block diagram of the controller without burst mode.

FIG. 14 shows a schematic diagram of the controller.

### DETAILED DESCRIPTION OF THE PREFERRED EMBODIMENTS

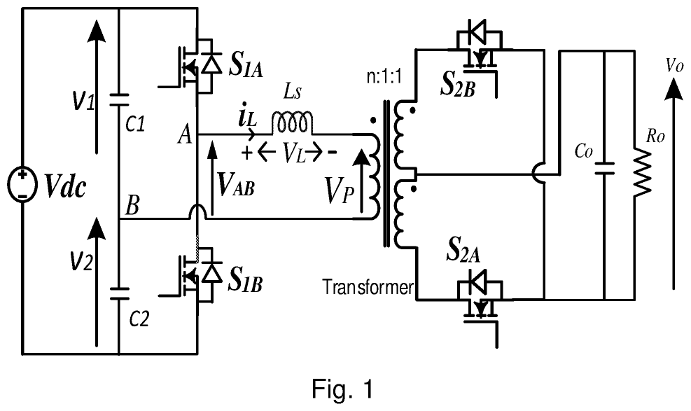

The preferred circuit configuration is depicted in FIG. 1. The circuit consists of a half-bridge converter followed by an inductor to feed AC input to a high frequency transformer and then a synchronous rectifier to rectify the AC output to desired DC output. Power transfer is performed by energizing and deenergizing of the inductor, L_{S}. Two DC link capacitors, C₁ and C₂ are connected in series across the input voltage, V_{dc}. Voltage across the capacitors C₁ and C₂ are V₁ and V₂ respectively. During steady state, it can be considered that both the voltages are same and denoted by V_{C}. When switches S_{1A} and S_{1B} are alternately activated, an alternating current pass through the inductor L_{S} at the switching frequency, and with a maximum peak voltage between node A and node B of about ±% V_{D}C.

On the secondary side, capacitor, C₀ is connected to filter out AC current ripple of the rectified current. A voltage drop occurs across series inductor at the primary of the converter. The transformer is, for example, a 16:1:1 turns ratio transformer which then further step down the primary side voltage of the transformer. With load Ro, the frequency of switching of S_{1A} and S_{1B} is controlled such that the output voltage V_{O} is maintained at a desired value. S_{2A} and S_{2B} are operated as a synchronous rectifier, and therefore are controlled for maximum efficiency in a generally load-independent manner. The controller is feedback controlled based on an input reference voltage and the output voltage Vₒ, and varies the frequency of pulses to control power transfer. The control further provides a peak current control based on a predetermined reference. As shown in FIG. 4, the control is symmetric, and has a separate upper and lower bound detection, which is implemented as a pair of logical AND gates, receiving the output of the level detector and the peak detector. The peak detector receives a rectified peak corresponding to the current in the inductor, which is compared with a peak current reference value. The level detector receives a signal corresponding to the current in the inductor, and produces a set of pulses for the secondary. These pulses may be further controlled to achieve burst mode control. As shown in FIG. 10, the feedback control is provided by a negative feedback input of the difference between V_{O} and a reference voltage, to a proportional-integral controller, which controls the duty cycle of a variable duty cycle pulse generator, which in turn is modulated by the level detector (positive and negative). Note that in some cases, the positive and negative pulses may differ in characteristics, e.g., in pulse width, to account for polarity asymmetries in the converter or the load, though this is typically not necessary.

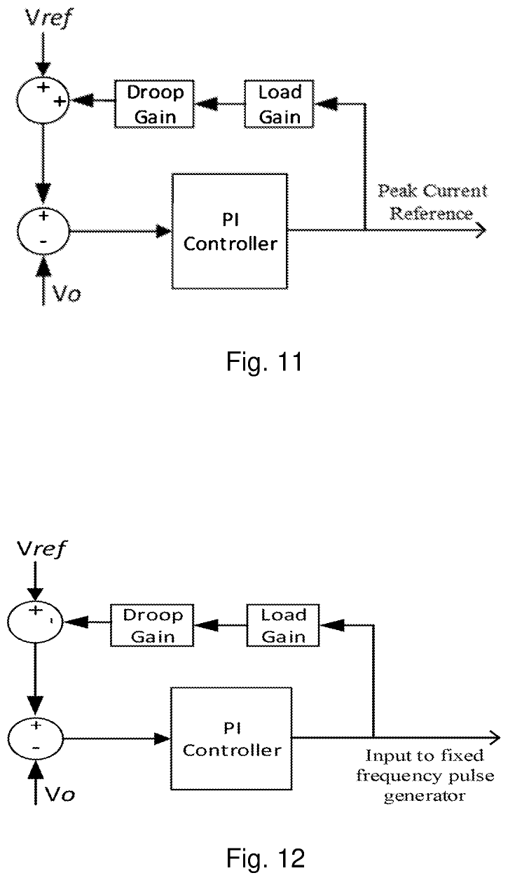

As shown in FIGS. 11 and 12, the feedback into the proportional-integral controller may have elements corresponding to the load gain and the droop gain, to adjust the setpoint of the controller.

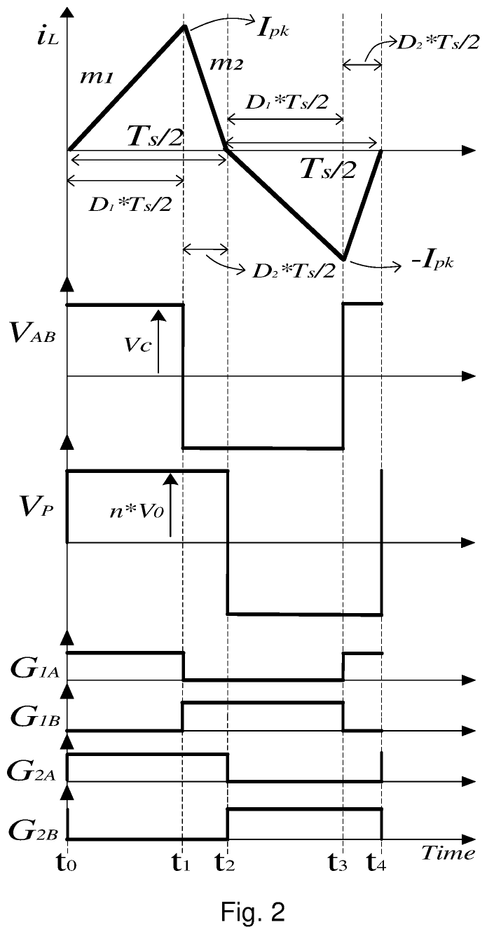

Current through L_{S} and voltage across the primary winding corresponding to different gate pulses to the switches are presented in the FIG. 2. Here, current through L_{S}, i_{L} is shown with different gate pulses, G_{1A}, G_{1B}, G_{2A} and G_{2B} corresponding to the switches S_{1A}, S_{1B}, S_{2A} and S_{2B} respectively. To avoid dead-short of capacitors C₁ and C₂, gate pulses G_{1A} and G_{1B} must be complementary to each other. Similarly, gate pulses G_{2A} and G_{2B} should be complementary to each other to achieve maximum power transfer to load end corresponding to a fixed inductor current. Also, this avoids circulating current on the secondary windings. For simplicity, no dead-time is depicted between complementary gate pulses.

The saturable inductor imposes a delay between the waveform V_{AB} and V_{P} across the transformer primary. The switches S_{2A} and S_{2B} are switch responsive to the ZVS condition of V_{P}.

The small signal transfer function of output voltage, V₀ to one complete cycle time period, T_{S} can be written as

$$\frac{( s )}{( s )} ,$$

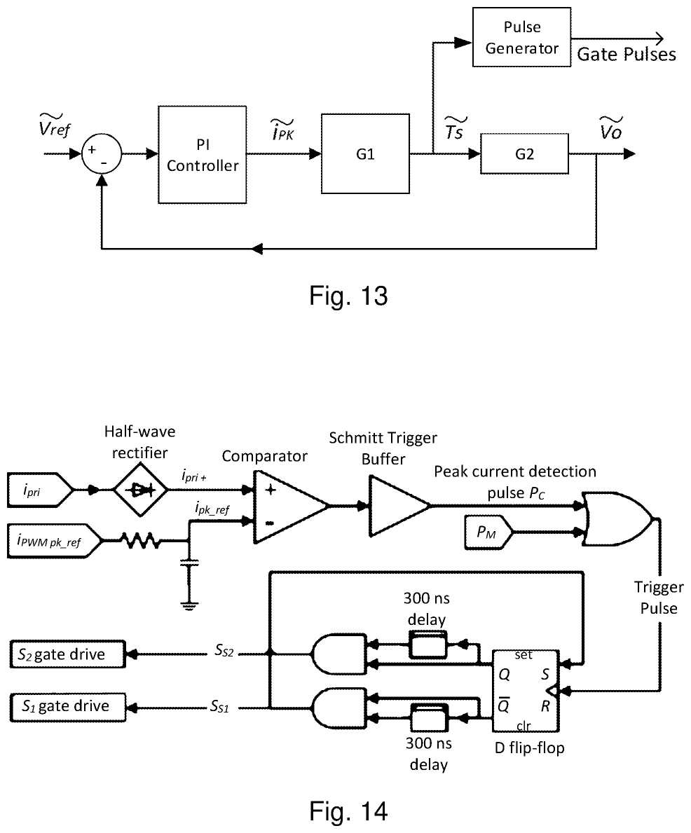

which thus defines a variable frequency dependent on the feedback, i.e., V_{O}, and the inductor current i_{L}, which are not independent (orthogonal) variables. A type-II proportional-integral controller is used for the outer voltage loop control. FIG. 13 shows a block diagram of a controller absent the burst mode. The transfer function is expressed as a chain G(s)=G₁(s)•G₂(s) of

$${G}_{1} ( s ) = \frac{( s )}{( s )} and {G}_{2} ( s ) = \frac{( s )}{( s )} .$$

G₁(s) is responsive to the peak current in the inductor, while G₁(s) is responsive to the output voltage.

FIG. 14 shows a schematic of the controller. A sensor provides a signal iₚᵣᵢ representing the current through the inductor, which is then rectified with a half-wave rectifier, and compared with a filtered reference level i_{pk_ref} from i_{PWM pk_ref} with a comparator with hysteresis (Schmitt Trigger Buffer). The comparator output peak current detection pulse P_{c} is then fed to an OR gate along with a pulse P_{M}, to provide a trigger pulse to a D-type Flip Flop. The leading edge of the Q(S₂ gate drive) and not-Q (S₁ gate drive) outputs of the D-flip Flop, and a 300 nS delayed representation of the respective output, are fed to an AND gate. The S_{S1} gate drive is fed back to the Set input S of the D-Flip Flop.

At steady state different mode of operations are described below:
Mode I (t₀-t₁): At time, t₀ the switch S_{1A} is turned-on and S_{1B} is turned-off. Voltage across the node A and B, V_{AB} is V_{C}. Current through L_{S}, i_{L} keeps on increasing with a slope,

$${m}_{1} = \frac{{V}_{c} - {nV}_{0}}{{L}_{S}} \qquad ( 1 )$$

as shown in the FIG. 2. Here n and V₀ are transformer turns ratio and output voltage respectively. S_{2A} is turned-on and reflected secondary current, i_{S} flows to load-end. At the end of this interval i_{L} reaches to its positive peak value, Iₚₖ. Voltage, Vₚ, across the primary winding of the high frequency transformer is the reflected voltage from secondary side when secondary switches are turned-on. Hence, Vₚ equals to nV₀.
Mode II (t₁-t₂): During mode II, switch S_{1A} is turned-off and S_{1B} is turned-on. Voltage V_{AB} is −V_{C} and voltage Vₚ, equals to nV₀, since S_{2A} is still turned-on. This initiates reduction of current, i_{L} with the slope,

$${m}_{2} = \frac{- {V}_{c} - {nV}_{0}}{{L}_{S}} \qquad ( 2 )$$

i_{S} flows to load-end on the same path as in previous mode. At the end of this interval i_{L} reaches to zero.
Mode III (t₂-t₃): During this interval, switch S_{1A} and S_{1B} are kept turn-off and turned-on respectively. At time t₂, S_{2B} is turned-on and S_{2A} is turned-off. Voltages V_{AB} is −V_{c} and Vₚ, equals to −nV₀. This further decreases current, i_{L} with slope,

$${m}_{3} = \frac{- {V}_{c} + {nV}_{0}}{{L}_{S}} \qquad ( 3 )$$

Current, i_{L} keeps on decreasing till it reaches to negative peak, −Iₚₖ.
Mode IV (t₃-t₄): In mode IV, switch S_{1A} is again turned-on and S_{1B} is turned-off. Gate pulses to the synchronous rectifier switches are as in the mode III. Voltages V_{AB} is V_{C} and V_{P}, equals to −nV₀. This assists in increment of current, i_{L} with the slope,

$${m}_{4} = \frac{{V}_{c} + {nV}_{0}}{{L}_{S}} \qquad ( 4 )$$

At the end of this interval, i_{L} becomes zero. During the steady-state, intervals t₀ to t₂ and t₂ to t₄ are equal. Therefore from (1), (2), (3) and (4), peak current of i_{L} is expressed as,

Iₚₖ=V_{C}²−(nV₀)²/4V_{C}L_{S}f_{S} (5)

where f_{S} is the reciprocal of T_{S} and T_{S} is the total time interval from the time instant t₀ to t₄. From (5), it is evident that with a fixed V₀, V_{C} and L_{S}, I_{PK} is inversely proportional to frequency, f_{S}. From the FIG. 1, at output end, secondary current of HFT is rectified by a center-tapped synchronous rectifier.

Control and Design Analysis:

From FIG. 1, at the output end, secondary current of the high frequency transformer is rectified by a center-tapped synchronous rectifier. Hence, having a triangle shape of i_{L}, load current can be written as, I₀=ni_{L/}_{₂}. From (5), for a fixed inductor, f_{S} varies with load current.

A. Peak Current Controller

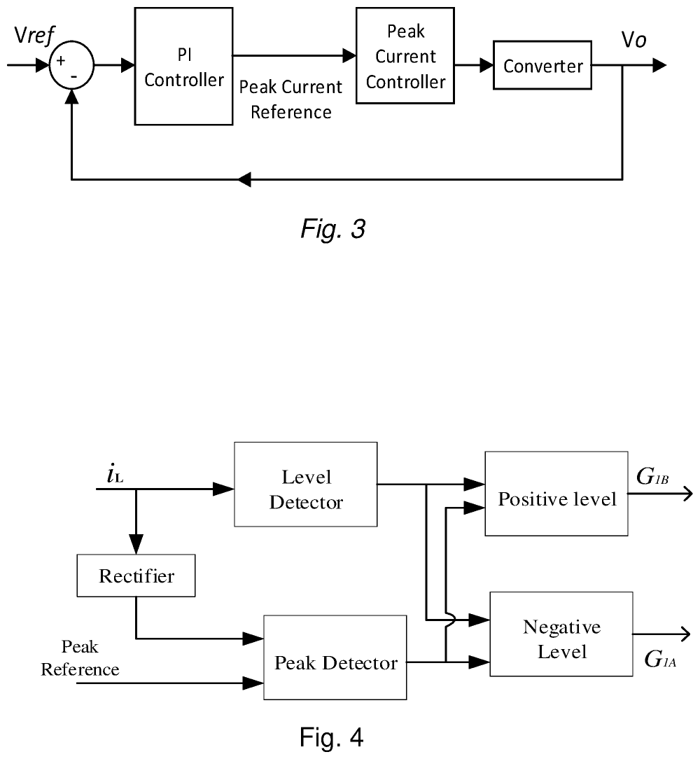

Considering the very fast dynamic requirement for the Point of Load application, a closed loop voltage controller is designed with an inner peak current control loop (Ye et al. (2018)) as shown in the FIG. 3.

The outer voltage proportional-integral controller sets the reference for the peak current of the inductor. For the subsequent peak current controller stage, first i_{L} is sensed and rectified and then fed to a peak detector circuit. There are two peaks of i_{L}, positive and negative peak. The absolute magnitude of both positive and negative peak should be equal, otherwise an average DC current can increase the unnecessary flux density level of the high frequency transformer. To get rid of this, equal turn-on time is necessary for each switch of half bridge.

A block diagram representation of gate-pulse generation for a half bridge converter is depicted in FIG. 4. Rectified i_{L} is compared with peak reference, derived from the proportional-integral controller. The proportional-integral controller is implemented digitally. Realization of peak detection is achieved using a mixture of analog and digital circuit components. A mimic of the peak reference is generated corresponding to the output of the proportional-integral controller. One pulse of fixed frequency with variable duty cycle according to a peak reference is generated. This pulse is then filtered using a low pass filter to generate the peak reference.

This is compared with the actual rectified inductor current. The positive and negative half of i_{L} are detected by level sensors. The output of the peak-detector pulse combined with positive and negative level, trigger the turn-on sequences of the half bridge converter as shown in FIG. 4. When i_{L}, in the positive half, equals to peak reference switch S_{1A} is turned-off and S_{1B} is turned-on. Similarly, during the negative half, at the peak of i_{L} switch S_{1A} is turned-on and S_{1B} is turned-off. The peak reference defines switching time. Thus, during steady-state, both the turn-on spans are equal and peak current controls output voltage.

The small signal transfer function of output voltage, V₀ to peak current Iₚₖ can be written as,

$$G ( s ) = \frac{( s )}{( s )} = \frac{2 {nL}_{s} {V}_{dc} {R}_{o}}{4 {sC}_{o} {R}_{o} {V}_{dc} {L}_{s} + ( 4 {V}_{dc} {L}_{s} + {n}^{3} {V}_{o} {R}_{o} {T}_{s} )} \qquad ( 6 )$$

For the secondary side, gate pulse generation for the switches S_{2A} and S_{2B} is done by detecting the state of i_{L}. During positive-half of i_{L}, S_{2A} is turned-on and S_{2B} is turned-off. On the other side, during negative-half of i_{L} S_{2A} is turned-off and S_{2B} is turned-on.

As shown in FIG. 10, the positive and negative half of i_{L} are detected by level sensor. The output of peak-detector pulse combined with positive and negative level, trigger the turn-on sequences of the half bridge converter as shown in FIG. 4. When i_{L}, in the positive half, equals the peak reference, switch S_{1A} is turned-off and S_{1B} is turned-on. Similarly, during the negative half, at the peak of i_{L}, switch S_{1A} is turned-on and S_{1B} is turned-off. The peak reference defines switching time. The small signal transfer function of output voltage, V₀ to one complete cycle time period, T_{S} can be written as,

$$\frac{( s )}{( s )} = \frac{{nR}_{o} ( {{V}_{dc}}^{2} - {( {nV}_{o} )}^{2} )}{4 {sC}_{o} {R}_{o} {V}_{dc} {L}_{s} + ( 4 {V}_{dc} {L}_{s} + {n}^{3} {V}_{o} {R}_{o} {T}_{s} )}$$

At the secondary side, switching of S_{2A}, S_{2B} is done by detecting i_{L}. While i_{L} is positive S_{2A} is turned-on and S_{2B} is turned-off. Likewise, during negative-half S_{2A} is turned-off and S_{2B} is turned-on. A type-II proportional-integral controller is used for the outer voltage loop control. The input to the proportional-integral controller is the error between reference and the actual output voltage, V₀ as shown in the FIG. 3. The transfer function of the controller can be expressed in s-domain as,

$$H ( s ) = 170 \frac{s + {10}^{6}}{{10}^{6} s} \frac{1}{1 + 1.2 * {10}^{6} s}$$

FIG. 13 shows a block diagram of a controller without burst mode. The transfer function is expressed as follows, which differs slightly from (6):

$${G}_{1} ( s ) = \frac{( s )}{( s )} = \frac{4 {L}_{s} {V}_{dc}}{( {{V}_{dc}}^{2} - {( {nV}_{o} )}^{2} )}$$

$${G}_{2} ( s ) = \frac{( s )}{( s )} = \frac{{nR}_{o} ( {{V}_{dc}}^{2} - {( {nV}_{o} )}^{2} )}{4 {sC}_{o} {R}_{o} {V}_{dc} {L}_{s} + ( 4 {V}_{dc} {L}_{s} + {n}^{3} {V}_{o} {R}_{o} {T}_{s} )}$$

$$G ( s ) = {G}_{1} ( s ) \cdot {G}_{2} ( s ) = \frac{( s )}{( s )} = \frac{2 {nL}_{s} {V}_{dc} {R}_{o}}{4 {sC}_{o} {R}_{o} {V}_{dc} {L}_{s} + ( 4 {V}_{dc} {L}_{s} + {n}^{3} {V}_{o} {R}_{o} {T}_{s} )}$$

B. Saturable Inductor

Using the peak-current controller, the switching frequency f_{S} increases as the load is decreased. This leads to reduced efficiency at low load condition. The power electronics industry has to comply with stringent efficiency requirement applied by regulatory agencies like Energy Star and 80plus.org. See Feng et al. (2011), thus requiring attention to this issue.

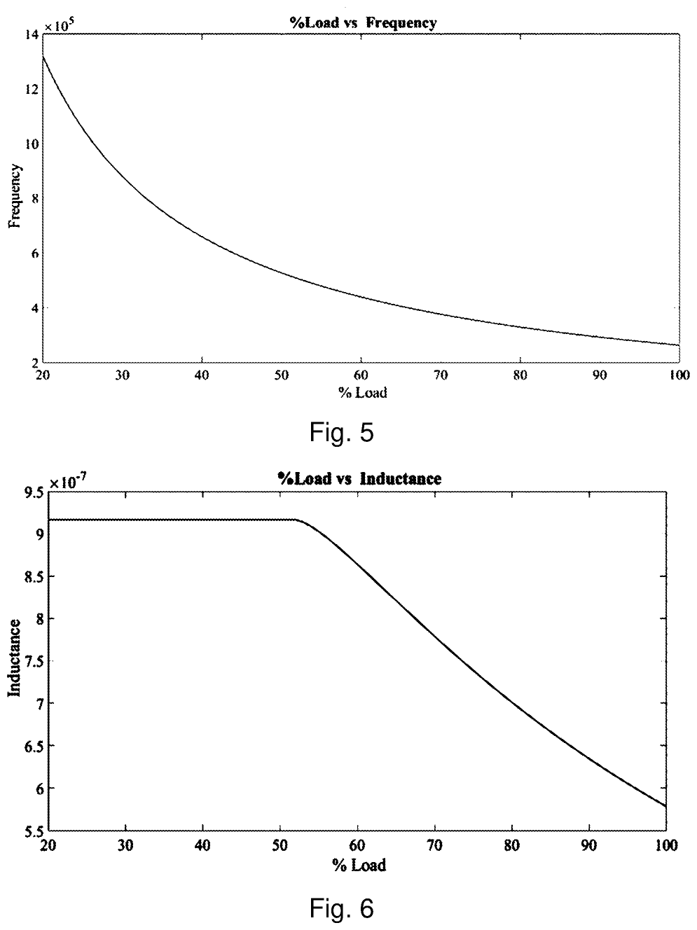

It is important to provide high efficiency from 20%-50% of full load of AC-DC converters for datacenter applications, with emphasis on improved efficiency of the DC-DC stage of the AC-DC power supply for datacenter applications. To handle this problem, from (5), an inductor of comparatively large inductance value can be selected. This drops the full load frequency, which increases DC-link capacitor size, inductor size, and particularly transformer size. Frequency excursion with an inductance of 685nH is shown in FIG. 5. The switching frequency increases from 250 kHz at full load to 1.35 MHz at 20% load. This high frequency incurs higher switching loss at light load. To address this issue, a saturable inductor is introduced. Inductance of the saturable inductor is dependent upon the current flowing through it. The inductance of a saturable reactor is defined by Dayerizadeh et al. (2018):

$${L}_{ef} = \frac{2 {L}_{S}}{π} ( {sin}^{- 1} ( \frac{{I}_{sat}}{{I}_{pk}} ) + \frac{{I}_{sat}}{{I}_{pk}} √ ( 1 - {( \frac{{I}_{sat}}{{I}_{pk}} )}^{2} ) ) \qquad ( 7 )$$

where, L_{ef} and Iₛₐₜ are the effective inductance due to saturation and the minimum current value for which the inductor gets saturated. According to (7), saturable inductor offers a progressively increasing inductance as the load is reduced.

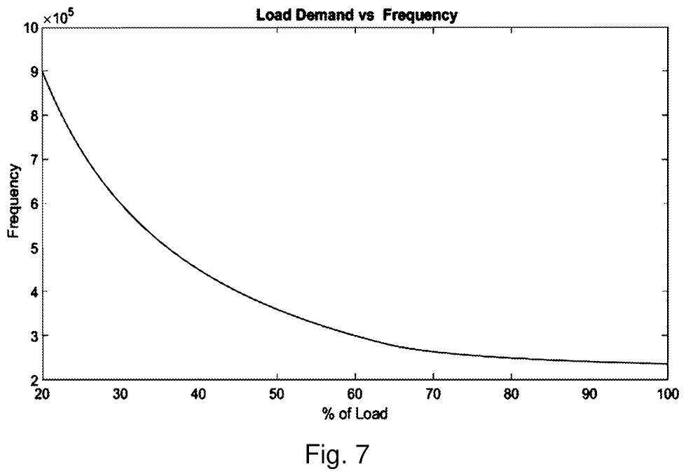

For the present application, core of the inductor is chosen such that at 52% of I_{pkfl} the inductor starts getting saturated and at full load, inductance drops by 63% of the initial value as shown in the FIG. 6. Here, I_{pkfl} is the peak current of i_{L} at rated load. With this saturable reactor, variation in f_{S} is plotted in FIG. 7. While designing the inductor, the high frequency transformer is designed with 1% of leakage inductance and a magnetizing inductance of 10 μH. At 20% of load, f_{S} is 900 kHz. From the FIG. 5 and FIG. 7, it is evident that with incorporation of the saturable inductor, reduction of f_{S} is more than 150 kHz at load less than 50% load. Application of saturable reactor deviates i_{L} from being a triangular shape as shown in the FIG. 8 with more than 52% load. Switching sequences in all the modes are the same as in FIG. 2.

The modes with the saturable inductor differ from without, and are expressed as follows:
Mode I (t₀-t₁): At the beginning in this i_{L} follow the straight line with the slope m₁ until it reaches Iₛₐₜ. After that, inductance keeps on varying according to (7). As a result, i_{L} continues to increase with a changing slope,

$${m}_{1 s} = \frac{{V}_{c} - {nV}_{0}}{{L}_{ef}} \qquad ( 8 )$$

All the other voltage waveforms and gate pulses remain same as in the FIG. 2. At time t₁, i_{L} reaches Iₚₖ.
Mode II (t₁-t₂): After t₁, due to alteration of switching as depicted in FIG. 8, i_{L} starts decreasing with a variable slope of

$${m}_{2 s} = \frac{- {V}_{c} - {nV}_{0}}{{L}_{ef}} \qquad ( 9 )$$

Mode III (t₂-t₃): During this interval, switch S_{1A} and S_{1B} are kept turn-off and turned-on respectively. At time t₂, S_{2B} is turned-on and S_{2A} is turned-off. Voltages V_{AB} is −V_{C} and V_{P}, equals to −nV₀. This further decreases current, i_{L} with slope,

$${m}_{3 s} = \frac{- {V}_{c} + {nV}_{0}}{{L}_{ef}} \qquad ( 10 )$$

At the end of this interval, i_{L} becomes −Iₚₖ.
Mode IV (t₃-t₄): After t₃, voltages V_{AB} is V_{C} and Vₚ, equals to −nV₀. Since i_{L} is less than −Iₛₐₜ, i_{L} keeps on increasing with the slope,

$${m}_{4 s} = \frac{{V}_{c} + {nV}_{0}}{{L}_{ef}} \qquad ( 11 )$$

until it equals −Iₛₐₜ. Then i_{L} gradually increases with the slope m₄ and finally equals to zero. At steady-state, intervals t₀ to t₂ and t₂ to t₄ are equal.

Burst Mode Control

Light load efficiency is improved by reducing the operating frequency range with the help of the saturable inductor instead of a regular inductor, as discussed above. Though it assists in enhancing light load efficiency, at very light load the operating frequency can shoot up to more than 1 MHz. The input bus voltage V_{dc} is variable and it may increase up to 20% more. From (5), it is clear that increment of V_{dc} can increase light load frequency further. All these induce switching related losses in converter. On top of that magnetic, components operating at higher frequency also introduce higher core losses. Operation of the converter at very high frequency, e.g., more than 1 MHz, brings various complexities, including issues of sensing high frequency peak inductor current, implementation of a controller using analog circuitry and a computational time constraint for digital controller execution. EMI issues degrade the reliability of the converter.

To address these issues, various approaches have been devised. Generally, a fixed maximum high frequency of gate pulses are intermittently fed repeatedly to a driver circuit for the devices, to transfer power from source to the load end. The duration, during which power is fed to the load end with high frequency gate pulses, called “burst mode on time” and the duration during which high frequency pulses are blocked and no power is fed to the load end is called “burst mode off time”. In hysteretic burst mode control, blocking direction is enforced by the voltage loop feedback control. Texas Instruments, “Datasheet of UCC25700: 8-Pin High-Performance Resonant Mode Controller”, March 2009; Fang, Yu, Dehong Xu, Yanjun Zhang, Fengchuan Gao, Lihong Zhu, and Yi Chen. “Standby mode control circuit design of LLC resonant converter.” In 2007 IEEE Power Electronics Specialists Conference, pp. 726-730. IEEE, 2007, doi: 10.1109/PESC.2007.4342077.

This demands an extra circuit to implement the hysteresis loop, and also light load detection is not precise with this method.

Sun, Julu, Ming Xu, Yuancheng Ren, and Fred C. Lee. “Light-load efficiency improvement for buck voltage regulators.” IEEE Transactions on Power Electronics 24, no. 3 (2009): 742-751 provides an on time control method along with a customized non-linear inductor adopted to enhance light load efficiency in buck converter topology. Conduction loss is minimized but frequency related loss is not addressed.

In topologies where pulse frequency modulation is the approach for voltage regulation, light load efficiency enhancement is difficult to achieve. In LLC converters, different approaches are employed to control improve light load efficiency. See, Feng et al (2011), Jiang et al (2018), Shi et al. (2019), Chen et al. (2017), Chen et al. (2016), Lin et al. (2022), Shafiei et al. (2015), Matsuura et al. (2020), and Zhao et al. (2021). Constant on time, optimal switching pattern are introduced to extend light load efficiency in Feng et al. (2011) and Jiang et al. (2018). These methods demand DC load current detection which increases cost and reduces reliability and power density. In other approaches, a light load condition is detected from resonant tank parameter information. Chen et al. (2017), Shafiei et al. (2015), Matsuura et al. (2020).

But all these methods demand external circuit components. Additionally, implementation of burst mode operation needs exact information about the resonant current which needs complex circuit implementation. The starting current due to burst operation in an LLC converter induces a large peak current in the resonant circuit, even more than that of a full load condition. This problem is addressed in Shi et al. (2019). To mitigate the peak resonant current, the phase shift method (PSM) is adopted which demands extra devices.

Compared to all these, a simpler method is approached which is independent of load current sensor and normal circuit components statistical spread variations. Also, peak current during light load is constant and much less than the full load peak current. The burst mode control does not vary the light load frequency, even with the variation in V_{dc}. Burst mode operation starts up after load reduces to less than predefined 20% of full load. Above that, the normal mode of operation is performed as discussed above.

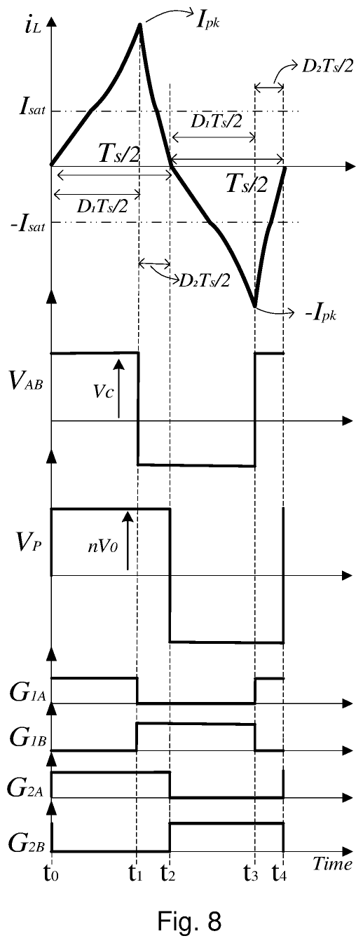

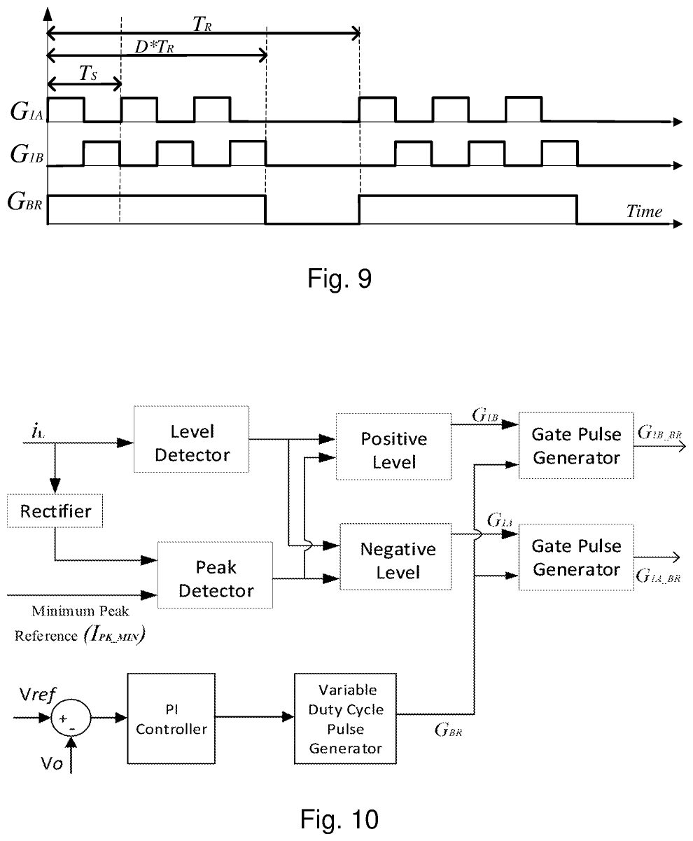

During burst mode operation, the switches keep on switching at the specified maximum frequency for a certain interval, and become idle for remaining time interval of a predefined constant frequency, T_{R}, as shown in the FIG. 9. Here, time period, T_{R}, of the fixed predefined frequency, is much longer than the regular high frequency gate pulse duration, T_{S}. To achieve maximum efficiency below the specified load limit, there is no need of variation in the high frequency gate pulse duration or adaptation of any particular switching sequence.

Only gate-pulses to the half-bridge are activated during DT_{R} interval as shown in the FIG. 9. Therefore, no extra effort is required to implement burst mode control, unlike in LLC converter burst mode control. This maximum frequency limit is set here at 900 kHz. No extra device count is required to implement this controller. Also, no extra sensor is necessitated to implement the required controller. Information from the previously mentioned proportional-integral controller is sufficient to detect the light load condition internally, and burst mode kicks in automatically.

Implementation of the burst mode controller is shown in FIG. 10. Generation of gate pulses during light load is performed with the blend of two different type of pulses: one is regular gate pulses corresponding to a minimum selected peak reference and another one is G_{BR}. Realization of G_{BR} is achieved using a proportional-integral controller followed by a comparison with a fixed frequency sawtooth waveform, as denoted by ‘Variable Duty Cycle Pulse Generator’. The input to the proportional-integral controller is an output voltage error, which confirms no use of an extra sensor. The minimum value of peak current, I_{PK_MIN}, is defined to keep the high frequency to a realizable maximum limit.

FIG. 3 and FIG. 10 show the implementation of the two proportional-integral controllers. During load variation from full load to set light load, the burst mode proportional-integral controller practically gives no response to output voltage variations. But, when load varies from full load condition to very light load, lower than the set minimum value, the two proportional-integral controllers interact with each other. To nullify this problem, droop control is added with the proportional-integral controller.

The drop control is realized without sensing load side DC current. Load current is calculated exactly using the peak current reference multiplied with a constant gain of an amount related to the turns ratio of transformer as shown in the FIG. 11. The peak current reference is multiplied by the load gain and the droop gain, and then added to the actual reference voltage, V_{ref}.

The load gain coefficient is used to calculate load demand from the peak reference. The peak current reference is used in the next stage for gate pulse generation for the half-bridge converter. By changing the different reference values for the two controllers, interaction between the two controllers is minimized. Also, two proportional-integral controllers, one for peak current generation and another for burst mode applications, have different bandwidth to minimize interaction between controllers. One more droop controller is used in the burst mode loop to achieve adaptive voltage positioning (AVP), as shown in the FIG. 12.

Similar to the droop control implementation in the peak current reference generation, here the proportional-integral controller output is multiplied consecutively with two constants, the load gain and the droop gain. In both the droop controller applications, load gain constant is fixed, but droop gains are different. With these two droop controls, interaction between the controllers as well as adaptive voltage positioning are realized.

As used herein, the word “about” means within +25% of the stated value, if there is a quantitative value mentioned.

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

What is claimed is:

1. A converter, comprising:
a transformer circuit, having a series inductor;
a half-bridge stage, comprising a first pair of switches, configured to receive electrical power and generate therefrom an oscillating waveform of an inductor current in the series inductor of the transformer circuit;
a synchronous rectifier stage, comprising a second pair of switches, configured to produce a rectified output from power transferred through the transformer circuit from the half-bridge stage; and
a controller, configured to produce switch control signals, which:
operate the first pair of switches in a soft switching mode to produce the oscillating waveform having a switching rate dependent on the rectified output of the synchronous rectifier stage, and a switching duty cycle dependent on the inductor current; and
synchronously operate the second pair of switches to produce the rectified output.

2. The converter according to claim 1, wherein the first set of switches are zero voltage switched.

3. The converter according to claim 1, wherein the second set of switches are zero current switched.

4. The converter according to claim 1, wherein the first set of switches are galvanically isolated from the second set of switches.

5. The converter according to claim 1, wherein the DC power is received at 48 V and the rectified output is less than 1.0 VDC.

6. The converter according to claim 1, wherein the DC power is received at 48 V and the rectified output is less than 0.5 VDC.

7. The converter according to claim 1, further comprising an output filter comprising a capacitor in parallel with a load.

8. The converter according to claim 1, wherein the transformer circuit comprises a center-tapped transformer.

9. The converter according to claim 8, wherein the center-tapped transformer has winding ratios of 16:1:1.

10. The converter according to claim 1, wherein the series inductor comprises a saturable inductor in series with a transformer winding, and the half-bridge stage is configured to generate the oscillating waveform of the inductor current in the saturable inductor in series with the transformer winding.

11. The converter according to claim 1, further comprising a pair of capacitors in series across the DC power, having a static node between the pair of capacitors, and the pair of switches are provided in series across the DC power and having a dynamic node between the pair of switches, wherein a primary of the transformer circuit comprising a saturable inductor in series with a transformer winding is connected between the static node and the dynamic node.

12. The converter according to claim 1, wherein the controller comprises a sensor-less droop control configured to calculate load demand current and perform quasi-peak cycle-by-cycle peak current control through a proportional-integral or proportional-integral-differential control algorithm.

13. The converter according to claim 1, wherein the controller is further configured to provide a burst mode to improve efficiency of operation of the DC-DC converter under light load conditions.

14. The converter according to claim 1, wherein the controller is configured to operate the first pair of switches in the soft switching mode to produce the oscillating waveform having the switching rate dependent on negative feedback of a magnitude of the rectified output and a switching duty cycle dependent on comparison of a magnitude of the inductor current with a reference peak current.

15. The converter according to claim 1, wherein the controller has a gain G(s)=G₁(s)•G₂(s) comprising a load gain
$${G}_{1} ( s ) = \frac{( s )}{( s )}$$
and a droop gain
$${G}_{2} ( s ) = \frac{( s )}{( s )} ,$$
wherein G₁(s) is responsive to a peak of the inductor current, while G₂(s) is responsive to the rectified output.

16. The converter according to claim 1, wherein the series inductor comprises a saturable inductor configured to offer a progressively increasing inductance as a load operating on the rectified output is reduced.

17. A method of operating a converter, comprising a first pair of switches at an input of a transformer circuit with a series inductor, configured to receive electrical power and to generate therefrom an oscillating waveform of an inductor current in the transformer circuit, and a second pair of switches at an output of the transformer circuit implementing a synchronous rectifier configured to produce a rectified output from power transferred through the transformer circuit, the method comprising:
controlling the first pair of switches in a soft switching mode to produce the oscillating waveform having a switching rate dependent on the rectified output and a switching duty cycle dependent on the series inductor current; and
controlling the second pair of switches to synchronously rectify the power transferred through the transformer circuit corresponding to the oscillating waveform to produce the rectified output.

18. The method according to claim 17, the first set of switches are zero voltage switched and the second set of switches are zero current switched, and the converter has at least one mode of operation in which a switching rate of the first pair of switches is controlled dependent on feedback representing a level of the rectified output, and a switching duty cycle of the first pair of switches is controlled dependent on a threshold level of the inductor current.

19. A controller for a voltage converter, comprising an input stage comprising at least one first pair of switches, configured to receive electrical power and generate therefrom an oscillating waveform, and at least one second pair of switches configured to synchronously rectify a product of the oscillating waveform coupled through a transformer circuit having an inductor current passing through a series inductor,
the controller comprising at least a proportional and integral processor comprising a negative feedback input corresponding to the synchronously rectified product, and being configured to produce switching waveforms for the at least one first pair of switches having a rate responsive to the negative feedback and a pulse width responsive to an inductor current driven by the at least one first pair of switches, and synchronous rectification switching waveforms for the second pair of switches.

20. The controller according to claim 19, further comprising
the transformer circuit, having the series inductor;
the first pair of switches which are zero voltage switched; and
the second pair of switches which are zero current switched.
